(19) United States
(12) Patent Application Publication
(10) Pub. No.: US 2019/0051201 A1
(43) Pub. Date: Feb. 14, 2019

(54) LEARNING SITUATION DETERMINING METHOD AND APPARATUS FOR PERFORMING THE METHOD

(71) Applicant: Ewha University - Industry Collaboration Foundation, Seoul (KR)

(72) Inventors: Il Hyun JO, Seoul (KR); Ye Ji OH, Chungcheongnam-do (KR); Jeong Hyun KIM, Seoul (KR); Youn Joo KIM, Gyeonggi-do (KR)

(21) Appl. No.: 16/059,702

(22) Filed: Aug. 9, 2018

(30) Foreign Application Priority Data
Aug. 10, 2017 (KR) 10-2017-0101697
Aug. 23, 2017 (KR) 10-2017-0106905
Nov. 1, 2017 (KR) 10-2017-0144498

(51) Int. Cl. G09B 7/02; G06F 3/01; G09B 5/06; G06K 9/00

(52) U.S. Cl. CPC G09B 7/02; G06F 3/015; G06F 3/013; G06K 9/00335; G09B 5/06

(57) ABSTRACT

A learning situation determining method and apparatus is disclosed. The learning situation determining method includes collecting psychophysiological response information of a learner on a first learning image, collecting stimulated recall response information of the learner based on a stimulated recall of the learner in response to a second learning image including a same learning content as the first learning image, determining cognitive load in the leaner that is recalled in each learning interval of the second learning image based on the psychophysiological response information and the stimulated recall response information. Alternatively, the learning situation determining method includes determining cognitive load in a learner learning a learning image for each learning interval of the learning image using psychophysiological response information of the learner based on prior knowledge possessed by the learner and task complexity of the learning image.

### CROSS-REFERENCE TO RELATED APPLICATIONS

This application claims the priority benefit of Korean Patent Application No. 10-2017-0101697 filed on Aug. 10, 2017, Korean Patent Application No. 10-2017-0106905 filed on Aug. 23, 2017, and Korean Patent Application No. 10-2017-0144498 filed on Nov. 1, 2017, in the Korean Intellectual Property Office, the disclosures of which are incorporated herein by reference for all purposes.

### BACKGROUND

### 1. Field

Example embodiments relate to a learning situation determining method and apparatus, and more particularly, to a learning situation determining method and apparatus that determines cognitive load in a learner occurring from a stimulus provided by a learning image and determines a learning level of the learner.

### 2. Description of Related Art

The development of information and communication technology has facilitated the establishment of an environment in which leaners learn things online anywhere at any time. Thus, online learning has become commonplace in educational fields such as schools and companies or in other learning environments for individuals. In addition, the development of information and communication technology has also facilitated the worldwide use of video learning, or multimedia learning, through smart devices. Such a learning method is provided in a form of microlearning that deals mainly with short videos, and thus spares learners from making extra time for learning unlike an existing face-to-face learning method. Thus, the demand for accessibility to and convenience of learning contents has also been increasing.

However, although video contents-based learning is widely used, instructional design activities are relatively less performed in the procedural organization of learning contents and the delivery of learning contents, compared to a traditional learning method that is performed in classrooms. Thus, a new instructional design suitable for the video learning is required because there is a limitation in applying an existing instructional design to the video learning due to a change to learning place- and learner-focused learning. For an effective instructional design, cognitive load in learners may need to be considered.

Recently, a stimulated recall methodology that observes a cognitive process of a learner is receiving a great attention. The stimulated recall methodology may be used to closely observe cognitive load in a learner that occurs in a learning process, and determine a learning interval in which the cognitive load occurs. However, the stimulated recall methodology is dependent on an intuition of a researcher in a process of selecting a recall stimulus, and may thus be limited to labor-intensive research because a researcher needs to analyze all responses of targets.

In addition, a method of identifying a behavioral pattern of a learner during learning and predicting an achievement level of the learner and cognitive load in a dropout or failed learner based on the identified behavioral pattern is also used. However, such a method may not be effective in determining learning psychology that acts on behaviors of the learner based on the behavioral pattern. In addition, to effectively use a learning analytics result for actual learning, a learning analysis process may need to be interpreted and fed back in close association with an instructional design. However, this method may be insufficient to provide a linkage or a model that enables situational and contextual interpretation of collected information or data.

As the importance of understanding behavioral, and cognitive and emotional changes of a learner during a learning process has recently been more emphasized, more attempts have been made to analyze and interpret cognitive and emotional states of the learner that change in the learning process based on psychophysiological responses of the learner. However, in a modern environment where social concern for extended learning or open learning is growing and cognitive loads are explosively increasing due to the inundation of alternative or substitute learning resources and information, measures to effectively manage such a growing number of cognitive loads in learners are required.

To this end, a cognitive load theory has been widely applied to educational technology to explain a cognitive situation of a learner and provide an instructional design supporting this. The cognitive load theory places emphasis on the construction and automation of schemas as a main goal of education or learning. It explains that an instructional design needs to be established to maximize germane cognitive loads, considering a relationship among three types of cognitive load and a limitation of available cognitive abilities.

However, previous research on the cognitive load theory has focused primarily on the reduction of extraneous cognitive loads, and lacks research on a learner's process of processing intrinsic information based on characteristics of an instructional design and a learner. Thus, it may not be easy to objectively measure cognitive load in a learner during an actual video learning process.

In addition, a learner may need to achieve a certain learning level in an emotional or psychological aspect based on a learning goal intended by an instructional designer based on cognitive load.

Thus, there is a desire for a method of objectively determining cognitive load in a learner during an actual video learning process and determining an accurate learning level of the learner, while overcoming limitations of a stimulated recall method.

### SUMMARY

Example embodiments provide a method and apparatus for collecting psychophysiological response information of a learner who learns a learning image and determining a cognitive state of the learner based on a relationship between a psychological state and a physiological state of the learner during a process of learning the learning image.

Example embodiments also provide a method and apparatus for collecting stimulated recall response information of a learner based on a stimulated recall of the learner in a process of relearning a same learning image as a learning image previously learned by the learner to collect psychophysiological response information of the learner, and more accurately tracking a recall stimulus that induces the stimulated recall from the previously learned learning image based on a learning content included in the learning image.

Example embodiments also provide a method and apparatus for comparing a cognitive state of a learner learning a learning image based on psychophysiological response information of the learner and a cognitive state of the learner based on stimulated recall response information of the learner, determining a learning time point of the learning image at which cognitive load in the learner occurs while the learner is learning the learning image, and additionally designing a learning level and an instructional method that are suitable for a cognitive level of the learner.

Example embodiments also provide a method and apparatus for analyzing prior knowledge possessed by a learner who learns a learning image and analyzing task complexity of the learning image, and determining cognitive load in the learner that occurs while the learner is learning the learning image.

Example embodiments also provide a method and apparatus for analyzing psychophysiological response information of a learner who learns a learning image to determine behavioral, and cognitive and emotional states of the learner that change while the learner is learning the learning image, and determining whether cognitive load in the learner occurs based on prior knowledge possessed by the learner and task complexity of a learning content included in the learning image.

According to an example embodiment, there is provided a learning situation determining method including collecting psychophysiological response information to determine a change in psychological state and physiological state of a learner learning a first learning image, playing a second learning image including a same learning content as the first learning image for which the learning is completed when the learning of the first learning image is completed, collecting stimulated recall response information marked on the second learning image in response to a stimulated recall of the learner learning the second learning image, and determining cognitive load in the learner that is recalled from the first learning image using the psychophysiological response information and the stimulated recall response information. Herein, the first learning image may be an original moving image, and the second learning image may include a mark of the stimulated recall of the learner, and a moving image used herein may indicate a video.

The collecting of the psychophysiological response information may include collecting the psychophysiological response information including brainwave information obtained by measuring a brainwave of the learner, pupil size information obtained by measuring a change in pupil size of the learner, and heart rate variability (HRV) information of the learner obtained by measuring a change in heart rate of the learner. Herein, a brainwave may indicate electroencephalogram (EEG).

The collecting of the stimulated recall response information may include recording a learning content recalled by the learner while the learner is learning the second learning image, dividing the second learning image into learning intervals based on a mark generation time at which a mark is generated by the learner, and classifying a stimulated recall characteristic of each mark indicated on the second learning image based on the recorded learning content.

The determining of the cognitive load may include measuring a change in psychophysiological response information on the first learning image, comparing cognitive load that is estimated through the change in psychophysiological response information of the learner and cognitive load that is verified through the stimulated recall response information of the learner, verifying a range and interval of the psychophysiological response information of the learner that is describable by cognitive load in the learner that is recalled during learning based on a result of the comparing, and measuring cognitive load in the learner that is recalled from the first learning image based on the verified range and interval of the psychophysiological response information of the learner.

The measuring of the change in psychophysiological response information may include measuring a change in brainwave information of the psychophysiological response information based on a perceptual response of a brain of the learner that occurs due to cognitive load in the learner.

The measuring of the change in psychophysiological response information may include measuring a change in pupil size information of the psychophysiological response information based on whether a pupil size of the learner increases due to cognitive load in the learner.

The measuring of the change in psychophysiological response information may include measuring a change in HRV information of the psychophysiological response information based on an HRV that is a change in interval of a heart rate period occurring due to cognitive load in the learner.

The comparing of the cognitive loads may include comparing a learning interval of the first learning image that includes each peak value corresponding to each of the change in brainwave information, the change in pupil size information, and the change in HRV information that are included in the psychophysiological response information, and a learning interval of the second learning image that includes a peak value corresponding to a change in cognitive load.

According to another example embodiment, there is provided a learning situation determining method including collecting psychophysiological response information on a first learning image from a learner learning the first learning image based on prior knowledge possessed by the learner, providing the learner with a second learning image which is different from the first learning image in terms of task complexity when the learning of the first learning image is completed, collecting psychophysiological response information on the second learning image from the learner learning the second learning image, analyzing the psychophysiological response information collected while the learner is learning the first learning image and the second learning image based on the prior knowledge and the task complexity, and determining cognitive load in the learner for each learning interval based on the analyzed psychophysiological response information.

The collecting of the psychophysiological response information on the first learning image may include determining the prior knowledge through a pretest including a learning content to be learned by the learner before the learning of the first learning image begins, and classifying the learner into an upper group or a lower group based on the determined prior knowledge.

The analyzing of the psychophysiological response information may include analyzing the psychophysiological response information of the learner for each learning interval included in the first learning image and the second learning image by generating an average value of each of pupil size information and HRV information.

The analyzing of the psychophysiological response information may include analyzing the psychophysiological response information of the learner based on the pupil size information and the HRV information of the learner for each learning interval based on a level of task complexity that changes based on a time point at which the first learning image and the second learning image proceed.

According to still another example embodiment, there is provided a learning situation determining method including determining an achievement level of a learner based on whether a response to a question from the learner is correct, determining a tension level of the learner based on psychophysiological response information of the learner obtained while the learner is responding to the question, and determining a learning level of the learner based on the determined achievement level and the determined tension level of the learner.

The determining of the tension level of the learner may include determining the tension level based on the psychophysiological response information of the learner which is based on at least one of a skin conductance response based on an amount of sweat in a hand of the learner that perspires while the learner is responding to the question, HRV information measured while the learner is responding to the question based on a change in heart rate period, or a skin temperature of the learner that changes while the learner is responding to the question.

The determining of the tension level of the learner may include determining the tension level based on an average value of the psychophysiological response information in response to the question, and a basic response value of the learner.

The determining of the tension level of the learner may include determining the tension level based on a rank of types of the psychophysiological response information in response to the question.

In response to the achievement level being determined to be high and the tension level being determined to be high, the determining of the learning level of the learner may include determining the learning level to be a first type of learning level at which the learner may solve the question with knowledge possessed by the learner, a high level of concentration, and great effort.

In response to the achievement level being determined to be high and the tension level being determined to be low, the determining of the learning level of the learner may include determining the learning level to be a second type of learning level at which the learner may solve the question with a high level of expertise and less effort.

In response to the achievement level being determined to be low and the tension level being determined to be high, the determining of the learning level of the learner may include determining the learning level to be a third type of learning level at which the learner may not exhibit his/her ability due to anxiety although the learner wants to solve the question.

In response to the achievement level being determined to be low and the tension level being determined to be low, the determining of the learning level of the learner may include determining the learning level to be a fourth type of learning level at which the learner may pay less attention and make less effort.

The determining of the achievement level of the learner may include determining the achievement level to be high when the response to the question from the learner is correct, and determining the achievement level to be low when the response to the question from the learner is incorrect.

The determining of the tension level of the learner may include determining a type of tension level of the learner based on whether the response to the question from the learner is correct.

The determining of the tension level of the learner may further include providing the learner with follow-up learning determined based on the determined learning level of the learner.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a learning situation determining apparatus according to an example embodiment;

FIG. 2 is a flowchart illustrating an example of a learning situation determining method to determine cognitive load in a learner using psychophysiological response information and stimulated recall response information according to an example embodiment;

FIG. 3 is a diagram illustrating an example of a process of collecting psychophysiological response information and stimulated recall response information of a learner on a learning image according to an example embodiment;

FIG. 4 is a diagram illustrating an example of a process of collecting brainwave information, pupil size information, and heart rate variability (HRV) information that are included in psychophysiological response information of a learner according to an example embodiment;

FIG. 5 is a diagram illustrating an example of a change in psychophysiological response information of a learner for each learning interval and a change in cognitive load based on stimulated recall response information of the learner for each learning interval according to an example embodiment;

FIG. 6 is a diagram illustrating an example of a change in brainwave information for each learning interval and a change in cognitive load based on stimulated recall response information for each learning interval according to an example embodiment;

FIG. 7 is a diagram illustrating an example of a change in pupil size information for each learning interval and a change in cognitive load based on stimulated recall response information for each learning interval according to an example embodiment;

FIG. 8 is a diagram illustrating an example of a change in HRV information for each learning interval and a change in cognitive load based on stimulated recall response information for each learning interval according to an example embodiment;

FIG. 9 is a flowchart illustrating an example of a learning situation determining method to determine cognitive load in a learner using prior knowledge and psychophysiological response information according to another example embodiment;

FIG. 10 is a diagram illustrating an example of how prior knowledge and psychophysiological response information of a learner are collected according to another example embodiment;

FIG. 11 is a diagram illustrating an example of a correlation between prior knowledge and task complexity according to another example embodiment;

FIG. 12 is a diagram illustrating an example of a change in pupil size information of psychophysiological response information of a learner based on prior knowledge possessed by the learner according to another example embodiment;

FIG. 13 is a diagram illustrating an example of a change in HRV information of psychophysiological response information of a learner based on prior knowledge possessed by the learner according to another example embodiment;

FIG. 14 is a flowchart illustrating an example of a process of determining a learning level of a learner according to an example embodiment;

FIG. 15 is a diagram illustrating examples of types of learning level according to an example embodiment;

FIG. 16 is a diagram illustrating examples of types of follow-up learning provided based on a learning level of a learner according to an example embodiment; and

FIG. 17 is a diagram illustrating an example of a learning situation determining apparatus according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, example embodiments will be described in detail with reference to the accompanying drawings.

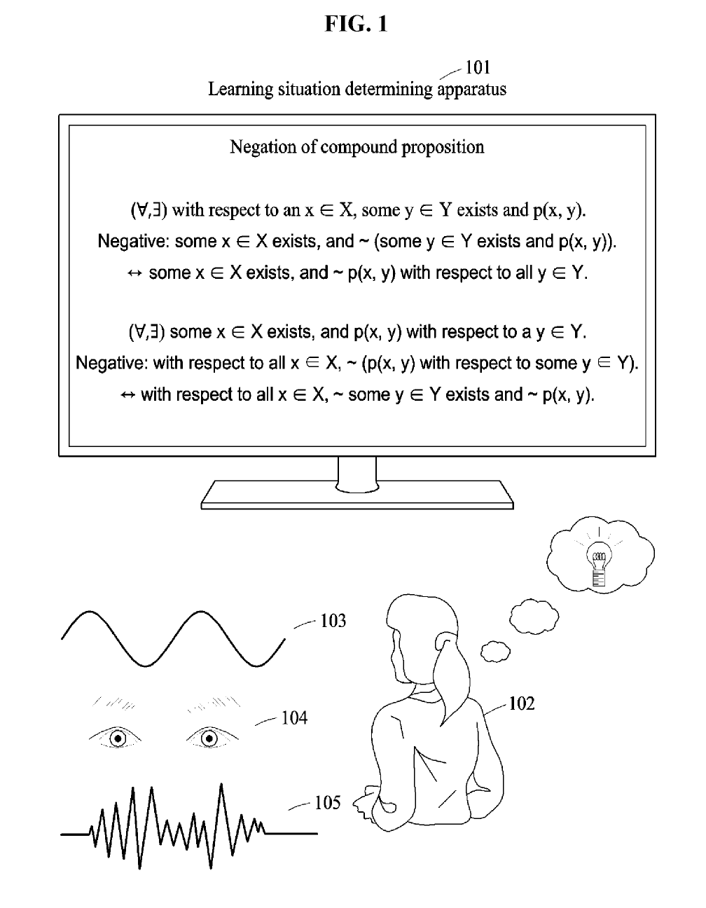

FIG. 1 is a diagram illustrating an example of a learning situation determining apparatus according to an example embodiment.

Referring to FIG. 1, a learning situation determining apparatus 101 may determine whether cognitive load in a learner 102 occurs while the learner 102 is learning a learning image based on two different types of information. In detail, the learning situation determining apparatus 101 may determine whether cognitive load in the learner 102 occurs based on psychophysiological response information and stimulated recall response information. In addition, the learning situation determining apparatus 101 may determine whether cognitive load in the learner 102 occurs based on prior knowledge and psychophysiological response information.

(1) A Learning Situation Determining Method Using Psychophysiological Response Information and Stimulated Recall Response Information

The learning situation determining apparatus 101 may determine cognitive load in the learner 102 from a learning content of the learning image in response to a stimulated recall of the learner 102 who learns the learning image. The learning situation determining apparatus 101 may determine this recalled cognitive load by collecting psychophysiological response information of the learner 102 while the learner 102 is learning the learning image.

In detail, the learning situation determining apparatus 101 may provide the learning image to improve an intellectual level of the learner 102. The learning image used herein may be an effective learning medium that may effectively transfer information difficult to be transferred in a form of text or picture and improve a level of concentration on or immersion in learning. Herein, the learning image may be a moving image, or a video. The learning image may include, for example, independent image information of a learner. In examples described herein, the learning image may be a learning image used to impart knowledge about a subject of mathematical propositions.

The learning image may be divided into learning intervals based on a learning content and a learning method included in the learning image, or an image content. For example, the learning image may be divided into, for example, an interval for learning a basic concept and an interval for applications. In the examples described herein, an image content about a subject of mathematical propositions may be divided into a total of 19 learning intervals based on a learning content or a suggested learning method.

The learner 102 who learns the learning image may experience cognitive load that is applied to a cognitive system of the learner 102 while the learner 102 is learning a learning content of the learning image and performing a task presented during the learning. That is, the learner 102 may experience an imbalance in the cognitive system due to an increase in information used for long-term memory of prior knowledge used to acquire new information through the learning image and of new knowledge obtained while the learner 102 is acquiring the new information, and may thus experience the cognitive load. The cognitive load may hinder the learner 102 from learning the learning image, and degrade a learning performance of the learner 102.

The cognitive load may be classified into intrinsic cognitive load, extraneous cognitive load, and germane cognitive load based on an individual learner, for example, the learner 102 in this example. In detail, the intrinsic cognitive load may occur due to task complexity of a task based on a learning image, and the task complexity may be determined by a level of interaction of components or by a level of prior knowledge possessed by a learner. The extraneous cognitive load may occur due to a type and a method of how learning materials and information are provided to a learner through a learning image. The germane cognitive load may be a load required for a learner when the learner solves a task in a learning environment, which may indicate a cognitive capacity or a cognitive resource for solving the task.

In addition, the cognitive load may be classified into instantaneous load, peak load, accumulated load, average load, and overall load based on how the cognitive load occurs in a learner. In detail, the instantaneous load may indicate cognitive load that occurs immediately while the learner is learning a learning image. The peak load may indicate a time point at which the instantaneous load is its peak. The accumulated load may indicate a total amount of individual loads experienced by the leaner while the learner is learning a learning image. The average load may indicate an average value of intensities of loads generated while the learner is learning a learning image. The overall load may indicate a total amount of cognitive loads perceived by the learner throughout an entire process of learning a learning image.

According to an example embodiment, it is possible to measure cognitive load in a learner in response to a learning image based on a psychophysiological response value measured from the learner who is learning the learning image. For example, the learning situation determining apparatus 101 may collect psychophysiological response information associated with a physiological state of the learner 102 and a psychological state of the learner 102 to measure cognitive load in the learner 102, and determine the cognitive load based on the collected psychophysiological response information.

In detail, the psychophysiological response information may indicate behavioral, and cognitive and emotional responses of a learner that are shown through a physiological state, for example, a physiological principle and phenomenon, of the learner. That is, the psychophysiological response information may be used to determine a cognitive state and a psychological state of a learner that change while the learner is learning a learning image, and it may be used itself as information to determine or complement the cognitive state of the learner. The psychophysiological response information may be biometric information on an unconscious response of the learner who learns a learning image. Thus, an unconscious psychological response of the learner may be obtained from the psychophysiological response information. The psychophysiological response information may be collected immediately during a learning process, and thus a change in psychological response of the learner may be measured based on time elapsed.

The psychophysiological response information may be information used to determine a psychological state of a learner based on a physiological state of the learner while the learner is learning ae learning image, and may include brainwave information, pupil size information, and heart rate variability (HRV) information. In addition, the psychophysiological response information may include, for example, information on a change of each facial part of a learner and a repetition of a behavior taken by the learner. That is, the psychophysiological response information may include, for example, information on a change in facial color of a learner due to a change in body temperature of the learner, and a movement and a size of each facial part of the learner. For example, the psychophysiological response information may be collected from a learner based on a degree of opening of a mouth of the learner, a behavior of touching a nose or an ear of the learner, a behavior of wiping sweat, a repetition of a behavior and movement, and the like that are shown while the learner is learning a learning image. Hereinafter, types of psychophysiological response information will be described.

Brainwave Information

A brainwave may indicate a biochemical response shown when a signal is transferred between cerebral nerves in a cerebral cortex nervous system of a learner, which may be an important indicator used to measure an active or activated state of a brain of the learner. A brainwave used herein may indicate electroencephalogram (EEG).

Brainwave information may indicate information on a frequency change of a bioelectric current generated in a brain. Herein, a frequency used as the brainwave information may include gamma waves in 30 to 50 hertz (Hz) and theta waves in 4 to 8 Hz, which are highly associated with a cognitive state and a memory storage of a learner for a learning image. For example, the brainwave information may be indicated as brainwave information 103 as illustrated in FIG. 1.

Herein, a gamma wave may include a wave indicating a wide range of sensory perception and increase when a high level of perceptual response is required, and may be used to measure working memory load that is applied due to a characteristic indicating a perceptual behavior of a learner. A theta wave may be associated with a working memory affected by an external stimulation, and interact with a gamma wave based on memory performance.

According to an example embodiment, brainwave data measured as brainwave information may be transformed through a fast Fourier transform (FFT), and stored in a form of a time-series signal that varies with time. Herein, the FFT may be performed to transform, into a discrete digital signal, the brainwave data in an analog form with successive time and amplitude. According to an example embodiment, it is possible to determine whether cognitive load in a learner increases or changes based on brainwave information by performing quantification on each frequency band to adjust a difference between individual learners in terms of brainwave. In addition, according to an example embodiment, it is possible to determine that cognitive load increases as the number of high frequency components increases in a brainwave power spectrum distribution by performing quantification based on a degree of bias of the power spectrum distribution through a relative power spectrum analysis and an absolute power spectrum analysis.

Pupil Size Information

A pupil may respond to various emotions and visual stimuli. A pupillary response, for example, constriction and dilation of pupils, may be a physiological response that occurs unconsciously and is not artificially controllable. Referring to FIG. 1, pupil size information 104 may be used to determine an intensity of an emotion of the learner 102 and a degree of cognitive load in the learner 102 based on how much a pupil of the learner 102 is dilated or on a pupil size of the learner 102. The constriction and dilation of a pupil, or a pupillary response, may be an eye-related behavioral response variable of the learner 102. For example, a pupil size may increase as cognitive load increases. This may be shown when the learner 102 activates a specific memory or is assigned with a difficult task. That is, the pupil size may change based on a level of task difficulty, and be used as an indicator of a cognitive state of the learner 102.

HRV Information

An HRV may be measured from a heart rate based on electrocardiogram (ECG) which is a bioelectric current generated when a heart is contracted. Referring to FIG. 1, HRV information 105 may be a variable measured from a variation in heart rate in a physiological phenomenon in which a time between heart rates changes based on an HRV, and be used as an indicator of a characteristic of an emotional or psychological state of the learner 102. Herein, a low HRV based on the HRV information 105 may indicate that the learner 102 is in a relaxed state, and a high HRV based on the HRV information 105 may indicate that the learner 102 is mentally stressed. Thus, the HRV information 105 may indicate an emotional or psychological response of the learner 102, and be used as an indicator to predict a degree of activation of sympathetic nerves and cognitive load from information processing.

Thus, the psychophysiological response information described above may be used to determine cognitive load in the learner 102, or a psychological phenomenon associated with learning, for example, attention, information processing, emotions, awakening, and the like of the learner 102 based on a learning context of the learning image. The psychophysiological response information may be indicated in Table 1 below.

TABLE 1

| Classification | Details |
|---|---|
| Brainwave | High beta wave/power spectrum distribution |
| Pupil size | Verify peak points in a pupil dilation graph, and |
| | determine a statically significant peak |
| HRV | An ECG rate changes drastically compared to |
| | a basic response |

According to an example embodiment, it is possible to determine a suitable learning level and additionally design a suitable instructional method by comparing the psychophysiological response information of the learner 102 and cognitive load recalled from a stimulated recall of the learner 102 in response to the learning image, and determining a start point of a learning interval at which the recalled cognitive load occurs.

Herein, the stimulated recall may indicate a method of inducing a learner to recall thoughts or impressions occurring while a certain activity or task is being performed, using a related visual or auditory recall stimulus after the activity or task is performed. Herein, a recall stimulus may be a clue and a stimulus that is provided to the learner when the stimulated recall is performed, and correspond to a learning image. That is, the stimulated recall may be used to allow a leaner to recall a cognitive process that occurs when a certain behavior or action occurs, using an audio or video tape recording the behavior or action.

In this example, to increase accuracy of a memory of the learner 102, stimulated recall response information on a stimulated recall of the learner 102 in response to the learning image may be collected, using a learning image including a learning content same as that of a learning image previously learned by the learner 102. The learning image may be classified into a first learning image and a second learning image to determine cognitive load recalled by the stimulated recall of the learner 102 learning the learning image. The first learning image and the second learning image may include the same learning content, and they may be distinguished by a mark or marking by the learner 102 in response to the stimulated recall. The first learning image may be an image associated with an original video, and the second learning image may include the same learning content as the first learning image and be an image including the mark indicated by the learner 102 in response to the stimulated recall.

Thus, in response to the stimulated recall of the learner 102 learning the second learning image, stimulated recall response information marked on the second learning image may be collected. Herein, the stimulated recall response information may be information including a same recall stimulus as in the first learning image, and in which all records recalled for each learning interval are marked throughout the second learning image. The stimulated recall response information may include information on recalled cognitive load in the learner 102.

To measure the recalled cognitive load in the learner 102 from the first learning image, a change in psychophysiological response information of the learner 102 and a change in cognitive load indicated by the stimulated recall response information may be compared.

That is, by comparing the stimulated recall response information on the cognitive load recalled through the recall stimulus and the psychophysiological response information used to determine cognitive load in the learner 102 based on a psychological state and a physiological state of the learner 102, it is possible to determine cognitive load recalled in response to a learning interval in which a cognitive imbalance between a time point at which cognitive load occurs based on the psychophysiological response information and a time point at which cognitive load occurs based on the stimulated recall response information occurs in the learner 102 during actual learning.

(2) A Learning Situation Determining Method Using Prior Knowledge and Psychophysiological Response Information

The learning situation determining apparatus 101 may determine cognitive load in the learner 102 based on prior knowledge and psychophysiological response information of the learner 102 by collecting the prior knowledge acquired by the leaner 102 before learning a learning image and collecting the psychophysiological response information of the learner 102 while the leaner 102 is learning the learning image.

That is, the learning situation determining apparatus 101 may determine cognitive load in the learner 102 during a learning process of the learning image in a video-based learning environment. Here, the video-based learning environment may indicate a learning environment that may create a new learning experience using digital technology including the Internet. For example, the learning situation determining apparatus 101 may determine cognitive load in the learner 102 through a learning process in such a video-based learning environment using a learning image for a subject of mathematical propositions including texts without any intervention of an instructor or teacher.

To determine cognitive load in the learner 102, the learning image may include one or more learning images that are different in task complexity. For example, the learning image may include a first learning image and a second learning image that change based on a time point at which the images proceed. In this illustrated example, the first learning image may include a learning interval for a universal proposition and an existential proposition, and the second learning image may include a learning interval for a compound proposition.

In detail, a learning situation may be deployed such that a precedent learning content with a lower level of task complexity is followed by a subsequent learning content with a higher level of task complexity. That is, the first learning image and the second learning image may represent a learning situation of the learner 102, and the first learning image may correspond to a precedent learning content of the second learning image and include a learning content with a relatively lower level of task complexity than the second learning image.

For example, the first learning image may include a learning content on a universal proposition and an existential proposition. In this example, the universal proposition and the existential proposition may be a precedent learning content of a learning content on a compound proposition included in the second learning image, which may correspond to a learning interval with a relatively lower level of task complexity and a relatively lower level of interaction among elements of the learning content, compared to a learning interval for the compound proposition. Thus, the compound proposition may include the learning content including the universal proposition and the existential proposition, and also a learning interval for a new learning content for the learner 102. In addition, the compound proposition may be a combination of the universal proposition and the existential proposition, and embodied by a process in which the number of elements to be understood as a learning content is relatively great, or interaction among the elements is considerably complex.

The learning situation determining apparatus 101 may determine cognitive load for each learning interval that occurs in the learner 102 while the learner 102 is learning the first learning image and the second learning image, based on task complexity of each of the first learning image and the second learning image.

The learning situation determining apparatus 101 may evaluate an academic process or learning process of the learner 102 and predict an academic or learning performance of the learner 102, by measuring, collecting, and analyzing contextual data to understand and optimize a learning environment. Herein, the learning performance may vary based on a type of learning image and a level of prior knowledge possessed by a learner who learns a learning image.

Thus, the learning situation determining apparatus 101 may determine prior knowledge possessed by the learner 102. That is, the learning situation determining apparatus 101 may perform a pretest based on a learning content of the learning image to be learned by the learner 102, and determine the prior knowledge of the learner 102 based on a result of the pretest. In the illustrated example, the learning situation determining apparatus 101 may determine a level of prior knowledge previously acquired by the learner 102, through a pretest on a subject of mathematical propositions. The learning situation determining apparatus 101 may then classify the learner 102 into an upper group or a lower group based on the determined level of prior knowledge.

The learning situation determining apparatus 101 may collect psychophysiological response information of the learner 102 that changes while the learner 102 is learning the learning image. Herein, the psychophysiological response information may include a cognitive response, an emotional response, and a behavioral response that are observed under physiological principles and phenomena of humans. The psychophysiological response information may include pupil size information, and HRV information which indicates an interaction between sympathetic nerves and parasympathetic nerves and is indicated as a ratio of low frequency (LF) to high frequency (HF), or an LF/HF ratio. The pupil size information may include information on a diameter of a pupil of an eye of the learner 102, and a change in pupil size information may be used as an indicator to estimate cognitive load and a cause of occurrence of the cognitive load. The HRV information may indicate a change in heart rate based on time, and a change in heart rate may be a response to an interaction between sympathetic nerves and parasympathetic nerves.

The learning situation determining apparatus 101 may determine cognitive load in the learner 102 based on the psychophysiological response information of the learner 102 that changes while the learner 102 is learning the learning image based on the prior knowledge possessed by the learner 102. That is, it is possible to determine a cognitive ability of the learner 102 while the learner 102 is learning the learning image based on the prior knowledge about a learning content included in the learning image to be learned by the learner 102. That is, it is possible to determine cognitive load in the learner 102 occurring while learning the learning image based on what the learner 102 is already known or learned, and processing and storing the learning content of the learning image in a memory of a brain of the learner 102. Thus, according to an example embodiment, when a learner has a higher level of prior knowledge, a less level of cognitive load may occur in the learner while the learner is learning a learning image. Conversely, when the learner has a lower level of prior knowledge, a higher level of cognitive load may occur in the learner while the learner is learning the learning image.

Thus, it is possible to determine cognitive load in a learner from a level of awareness of a learning content in a learning environment in which the learner learns a learning image, based on psychophysiological response information of the learner while the learner is learning the learning image based on prior knowledge possessed by the learner and a level of task complexity of the learning image.

In addition, it is possible to determine a learning level of the learner 102 based on a response to a question provided to the learner 102 in relation to a learning content of the learning image. For example, the learning level of the learner 102 may be determined when the learner 102 responds to a question provided through the learning situation determining apparatus 101. In this example, cognitive load may occur in the learner 102 by a stimulus provided by the learning image while the learner is learning the learning content of the learning image or preparing a response to the question. In addition, the psychophysiological response information of the learner 102 may also be measured and used to determine the learning level of the learner 102.

In an example, the learning situation determining apparatus 101 may provide a question to the learner 102. Herein, the question to be provided to the learner 102 may include at least one preset question, and whether a response to the question from the learner 102 is correct or incorrect may be determined. The learning situation determining apparatus 101 may receive, from the learner 102, the response to the provided question.

In addition, the learning situation determining apparatus 101 may determine an achievement level of the learner 102 based on whether the response to the question from the learner 102 is correct or incorrect. For example, when the response to the question from the learner 102 is correct, the achievement level of the learner 102 may be determined to be high. Conversely, when the response to the question from the learner 102 is incorrect, the achievement level of the learner 102 may be determined to be low.

Further, the learning situation determining apparatus 101 may measure psychophysiological response information of the learner 102 while the learner 102 is responding to the question. The learning situation determining apparatus 101 may determine a tension level of the learner 102 based on the psychophysiological response information of the learner 102 obtained while the learner 102 is responding to the question. For example, when the psychophysiological response information of the learner 102 obtained when the learner 102 responds to the question is greater than a preset threshold value, the tension level of the learner 102 may be determined to be high, or to be low otherwise.

Furthermore, the learning situation determining apparatus 101 may determine a learning level of the learner 102 based on the tension level determined based on the psychophysiological response information of the learner 102 along with the achievement level of the learner 102.

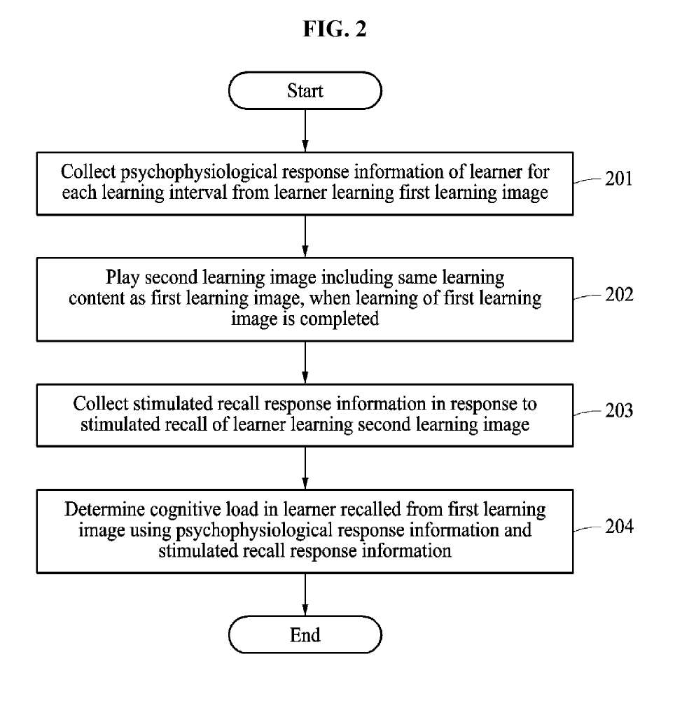

FIG. 2 is a flowchart illustrating an example of a learning situation determining method to determine cognitive load in a learner using psychophysiological response information and stimulated recall response information according to an example embodiment.

Referring to FIG. 2, in operation 201, a learning situation determining apparatus collects psychophysiological response information to determine a change in psychological state and a change in physiological state of a learner learning a first learning image. Herein, the psychophysiological response information may include brainwave information obtained by measuring a brainwave of the learner, pupil size information obtained by measuring a change in pupil size of the learner, and HRV information of the learner. The learning situation determining apparatus may perform the following to collect each piece of information included in the psychophysiological response information.

Brainwave Information

The learning situation determining apparatus may measure a brainwave, or EEG, generated while the learner is learning a learning image, and collect the brainwave information including a frequency band of a gamma wave and a theta wave in the brainwave. The learning situation determining apparatus may perform preprocessing to utilize a measured value of the brainwave information using a value obtained by subtracting, from brainwave data, an average brainwave value in a basic response interval.

For example, the learning situation determining apparatus may measure a brainwave generated while the learner is learning the learning image using an EEG measurer attachable to a forehead of the learner. In this example, through the EEG measurer, the brainwave information may be obtained when signals of two channels on left and right sides of frontal lobe positions FP1 and FP2 are sampled at 125 Hz for each channel, for example, a cut-off frequency of a low-pass filter being 32.75 Hz. The brainwave information measured through the EEG measurer may be recorded through a mobile phone that may be used as the learning situation determining apparatus or a dedicated application installed in such a mobile phone.

Pupil Size Information

The learning situation determining apparatus may collect the pupil size information to verify a change in cognitive load in the learner that occurs while the learner is learning a learning image, based on a pupil size as an unconscious response of the learner to the learning image. To measure a change in pupil size of the learner, the learning situation determining apparatus may measure the change based on an average value of changes in sizes of left and right pupils of the learner. The learning situation determining apparatus may perform preprocessing to utilize a pupil size value based on the pupil size information, using a value obtained by subtracting an average pupil size value in a basic response interval from pupil size data of the learner that is measured by a unit of 1/30 seconds. Herein, by fixing a gaze of the learner to a specific symbol, for example, X, indicated at a center of a screen on which the learning image is displayed, and measuring a basic response of the learner looking at the one point at certain time intervals, it is possible to minimize an eye adjustment response and an influence of difference in darkness and brightness on the pupils of the learner.

For example, the pupil size information may be collected from each of both eyes of the learner through an eyetracker throughout all learning intervals of the learning image.

HRV Information

The learning situation determining apparatus may collect the HRV information that is measured using an ECG signal and a heart rate of the learner, and indicates an intensity of an emotion felt by the learner and positiveness or negativeness of the emotion. For example, a heart rate and an HRV may be extracted from a photoplethysmogram (PPG) signal of a wrist of the learner.

In operation 202, when learning of the first learning image is completed, the learning situation determining apparatus plays a second learning image including a same learning content as the first learning image.

In operation 203, the learning situation determining apparatus collects stimulated recall response information marked on the second learning image in response to a stimulated recall of the learner learning the second learning image. In detail, the learning situation determining apparatus may record a learning content recalled from the learner while the learner is learning the second learning image. The learning situation determining apparatus may use a stimulated recall method to verify cognitive load in the learner occurred during a learning process. The stimulated recall method may be a post-introspection and observation method that may approach a memory of the learner using a visual or auditory clue and help the learner to recall thoughts, ideas, strategies, or the like occurred while the learner was conducting a certain behavior or task. The learning situation determining apparatus may provide a same type of learning image to the learner immediately after the learning image is learned to allow the learner to recall thoughts and the like of the learning image, and record the thoughts recalled in response to the provided learning image.

The learning situation determining apparatus may mark information at a time point at which cognitive load occurs from the learning image while the learner is replaying or playing back the learning image. Herein, the marking may be performed to classify marks based on whether the learning image is played back by the learner, and the marks may be recorded in a form of a simple memo of thoughts felt by the learner in a learning interval selected due to cognitive load. Herein, functions such as, for example, timeline movement, speed control and stop, and play, may be supported for the second learning image to allow the learner to freely control an image, and a function of making a memo of a recalled thought may also be supported.

The learning situation determining apparatus may classify a mark generation time at which a mark is generated by the learner for each learning interval of the second learning image.

The learning situation determining apparatus may classify a stimulated recall characteristic for each mark indicated on the second learning image based on a recorded learning content. Herein, a mark may indicate a mental effort indicating cognitive load, and indicate a record based on a cognitive state of the learner. The learning situation determining apparatus may classify a stimulated recall characteristic of a marker, based on a content of a memo recorded in an interval in which the mark is recorded, into ‘1’ when the stimulated recall characteristic increases, ‘-1’ when the stimulated recall characteristic decreases, and ‘0’ when the stimulated recall characteristic is null. That is, the learning situation determining apparatus may classify, into each value, a stimulated recall characteristic of each mark on a recorded memo. In addition, in response to each corresponding value, one of options, for example, A (anxiety), B (confidence), and C (mental effort), may be selected. For example, the learning situation determining apparatus may extract and use a value of a mark set as C (mental effort) which indicates cognitive load in the learner.

In operation 204, the learning situation determining apparatus determines cognitive load in the learner recalled from the first learning image, using the psychophysiological response information of the learner and the stimulated recall response information. In detail, the learning situation determining apparatus may measure a change in psychophysiological response information which changes based on cognitive load in the learner from the first learning image. The learning situation determining apparatus may measure a change in brainwave information of the psychophysiological response information based on a perceptual response of a brain of the learner that occurs due to cognitive load in the learner. The learning situation determining apparatus may also measure a change in pupil size information of the psychophysiological response information based on whether a pupil of the learner is dilated or not due to cognitive load in the learner. The learning situation determining apparatus may measure a change in HRV information of the psychophysiological response information based on an HRV of the learner, or a change in interval of a heart rate period occurring due to cognitive load in the learner.

The learning situation determining apparatus may measure cognitive load in the learner recalled from the first learning image by comparing the change in psychophysiological response information of the learner and the change in cognitive load indicated through the stimulated recall response information. The learning situation determining apparatus may compare cognitive load that may be estimated from the change in psychophysiological response information of the learner and cognitive load that may be verified from stimulated recall response information of the learner. The learning situation determining apparatus may determine a change in cognitive load in the learner that occurs during a learning process by comparing the cognitive load estimated from the psychophysiological response information and the cognitive load verified from the stimulated recall response information.

The learning situation determining apparatus may verify, from a result of the comparing, a range and an interval of the psychophysiological response information of the learner that may be describable by cognitive load in the learner recalled during the learning process. The learning situation determining apparatus may distinguish a range and an interval in which a recall occurs in the cognitive load estimated from the change in psychophysiological response information based on the cognitive load verified from the stimulated recall response information.

The learning situation determining apparatus may measure a recalled cognitive load in the learner from the first learning image based on the range and the interval of the psychophysiological response information of the learner. That is, the learning situation determining apparatus may measure the recalled cognitive load in the learner by comparing a learning interval of the first learning image in which a peak value of each of changes in brainwave information, pupil size information, and HRV information included in the psychophysiological response information is indicated, and a learning interval of the second learning image in which a peak value of a change in cognitive load is indicated.

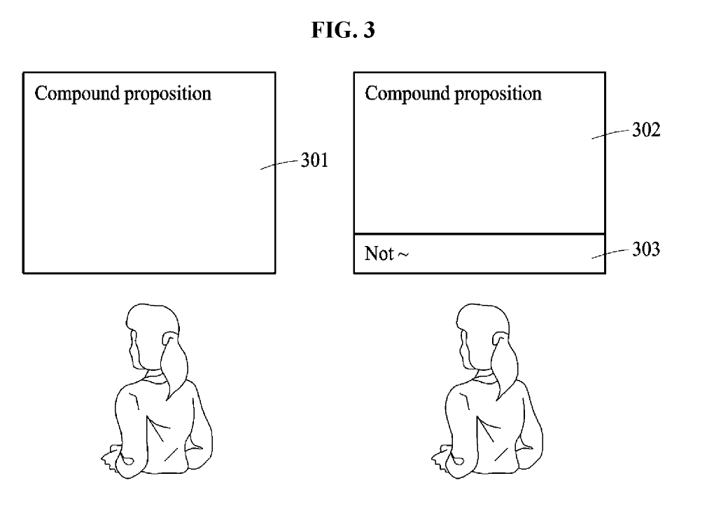

FIG. 3 is a diagram illustrating an example of a process of collecting psychophysiological response information and stimulated recall response information of a learner on a learning image according to an example embodiment.

A learning situation determining apparatus may determine recalled cognitive load in a learner in response to a learning image using stimulated recall response information. Referring to FIG. 3, the learning situation determining apparatus may classify the learning image into a first learning image 301 and a second learning image 302 that contain a same learning content. In this example, a background of the learning image may be provided in white to minimize extraneous cognitive load that may be caused by a learning content, and the learning content may be provide in a form of writing on a blackboard. In addition, when the learning image proceeds, a voice of an instructor of the learning content may be provided, but an image of the instructor may not appear.

As illustrated in FIG. 3, the learning situation determining apparatus may provide the first learning image 301 to the learner. The first learning image 301 may be a basic image used to provide new information to the leaner, and the learning situation determining apparatus may collect psychophysiological response information of the learner learning the first learning image 301. Herein, the learning situation determining apparatus may collect the psychophysiological response information by collecting psychophysiological response information for each learning interval classified based on a learning content included in the first learning image 301.

This is to collect the psychophysiological response information to explain a change in recalled cognitive load that is indicated through stimulated recall response information for each learning interval.

The learning situation determining apparatus may provide the second learning image 302 to the learner immediately after the learner completes learning the first learning image 301. The learning situation determining apparatus may mark information at a time point at which cognitive load occurs in the learning image while the leaner is replaying the learning image. Herein, the marking may be performed to classify markers based on whether the learner plays the learning image, and a mark may be recorded in a form of a simple note or memo of thoughts felt by the learner about a learning interval selected due to cognitive load. That is, it is possible to provide a learning environment to the learner to recall the learning image more freely by supporting functions that allow the learner to directly control the second learning image, for example, timeline movement, speed adjustment and stop, and play, and to record a memo of a recalled thought.

The learning situation determining apparatus may collect stimulated recall response information indicating a value measured from recalled cognitive load in the learner based on the memo in which the recalled thought is recorded and on the marked interval. That is, the stimulated recall response information may be a mental effort indicating cognitive load, and indicate a record based on the cognitive load.

The stimulated recall response information may be extracted in a form of Excel. The Excel includes elements such as an identification (ID) of the learner, an image number, a mark generation time, a mark classification, and a memo 303 as illustrated in FIG. 3. In detail, the ID of the learner is personal identification information. The image number is the number that classifies an image including a mark recorded by the learner in the first learning image and the second learning image. The mark generation time may be indicated by a unit of seconds of one decimal place in the second learning image controlled by the learner, and the mark classification may be recorded as a mental effort indicating cognitive load. The memo 303 may include a detailed explanation of a mark selected when the learner records a stimulated recall response.

Herein, cognitive load in the learner is classified into intrinsic cognitive load, extraneous cognitive load, and germane cognitive load based on how or why the cognitive load is generated. The intrinsic cognitive load may be generated by task complexity which is determined by a level of interaction among elements or a level of prior knowledge possessed by the learner. The extraneous cognitive load may be generated mainly by a form or a method of presentation of learning materials and information. The germane cognitive load may indicate a mental effort of the learner towards learning within a working memory capacity of the learner. The mental effort described herein may indicate germane cognitive load that is closely associated with a cognitive capacity or resource assigned to solve a task.

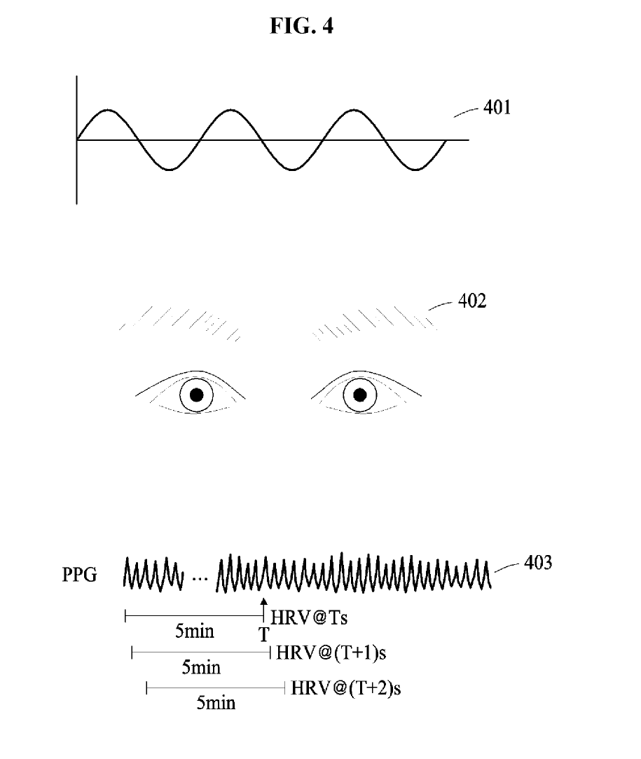

FIG. 4 is a diagram illustrating an example of a process of collecting brainwave information, pupil size information, and HRV information that are included in psychophysiological response information of a learner according to an example embodiment.

Referring to FIG. 4, a learning situation determining apparatus may collect psychophysiological response information of a learner in response to a learning image. The psychophysiological response information may include brainwave information, pupil size information, and HRV information, and each piece of information may be collected through the following operations.

Brainwave Information 401

The learning situation determining apparatus may analyze a change in bioelectric current frequency generated in a brain of a learner, and obtain an extracted brainwave. The learning situation determining apparatus may collect brainwave information by applying an FFT on the obtained brainwave. The FFT may be used to transform a time-domain signal into a frequency-domain signal to arrange brainwave signals in a graph based on a magnitude of frequency.

For example, the learning situation determining apparatus may process the extracted brainwave through the FFT (e.g., processing brainwave data at each 0.512 second), and classify blinks and brainwaves of the learner, and other noise based on a result of the processing. Subsequently, when the classified data is determined to be a brainwave, the learning situation determining apparatus may extract, from a determined signal, a sum of power spectral densities (PSDs) of an alpha wave region (8-12 Hz), a sensorimotor rhythm (SMR) wave region (12-15 Hz), a medium beta wave region (16-20 Hz), and a high beta wave region (21-30 Hz), as a parameter. Herein, the learning situation determining apparatus may use a high beta wave value associated with cognitive load. To remove an outlier, the learning situation determining apparatus may add an alpha wave value and a beta wave value at a certain time, add an average value and a standard deviation of sums of alpha wave values and beta wave values for 10 seconds before the time point, and remove the added value that is greater than the corresponding value.

To compare it to pupil size information and HRV information included in psychophysiological response information, the brainwave data processed through the process described above may be converted to an average value per second and be indicated by a unit of μV2/Hz. The brainwave data may be collected as the brainwave information included in the psychophysiological response information, and a brainwave or EEG may be represented by Equation 1 below.

Brainwave: Brainwave signal (Hz) collected at a corresponding point in time−average brainwave value in a basic response interval [Equation 1]

Pupil Size Information 402

The learning situation determining apparatus may measure a size of a left pupil and a size of a right pupil of a leaner that change in response to various emotions and visual stimuli. The learning situation determining apparatus may collect pupil size information as a value generated per second by subtracting an average pupil size in a basic response interval based on a change in pupil size.

For example, the learning situation determining apparatus may verify information on a distance between an eye of the learner and an eyetracker, and remove data of the distance between the learner and the eyetracker that is out of a range of 35 centimeters (cm) to 95 cm. In addition, the learning situation determining apparatus may separate an outlier deviating from a normal pupil size, for example, 1.5 millimeters (mm) to 6 mm, from the measured pupil size. Subsequently, the learning situation determining apparatus may calculate an average value per second, excluding an average pupil size in the basic response interval.

To compare the pupil size data processed through the process described above to the brainwave data at a same learning time point, the pupil size data may be converted to an average value per second and be indicated by a unit of mm. The pupil size data may be collected as pupil size information included in the psychophysiological response information, and the pupil size information may be represented by Equation 2 below.

Pupil size: Average value of left and right pupil sizes at a corresponding point in time−average pupil size value in a basic response interval [Equation 2]

HRV Information 403

The learning situation determining apparatus may measure an HRV as a value of change in heart rate period of a learner. A heart rate value of the learner may be indicated by a unit of beats per minute (bpm), and the change in heart rate period may be calculated to be an interval of 5 minutes by an attached device. By applying a sliding window method, a value may be measured at intervals of one second.

For example, the HRV may be a ratio between sympathetic nerves and parasympathetic nerves that is indicated by a unit of one second, for example, an LF/HF ratio, which may not be an absolute value measured by a change in heart rate, but a relative value obtained through an interval change. Thus, a basic response of the learner may not be applied to data preprocessing, and the LF/HF ratio may be calculated and generalized as a measured value. The HRV data may be a generalized value of the LF/HF ratio, and thus may not be indicated by a specific unit. The HRV information may be represented by Equation 3 below.

HRV: Ratio between sympathetic nerves and parasympathetic nerves, or LF/HF ratio [Equation 3]

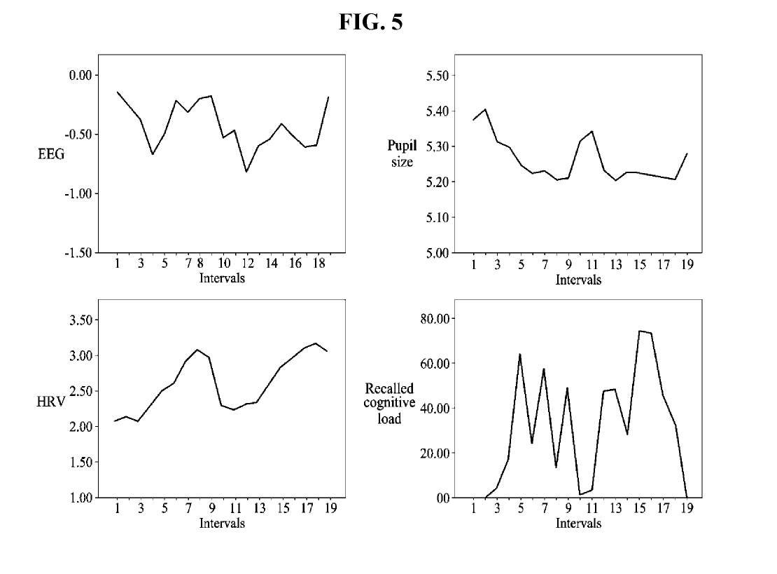

FIG. 5 is a diagram illustrating an example of a change in psychophysiological response information of a learner for each learning interval and a change in cognitive load based on stimulated recall response information of the learner for each learning interval according to an example embodiment.

Referring to FIG. 5, a learning situation determining apparatus may verify a change in recalled cognitive load in a learner based on psychophysiological response information of the learner for each learning interval in a process of learning a learning image. Herein, by converting, to an average value per second, a data unit of each piece of the psychophysiological response information as described above with reference to FIG. 4, a graph of each piece of the psychophysiological response information and recalled cognitive load may be formed as illustrated in FIG. 5.

That is, the learning situation determining apparatus may verify a change of each variable in each learning interval of the learning image, to compare the psychophysiological response information of the learner to a recalled cognitive load value and verify a psychological state of the learner based on the recalled cognitive load value. To verify the change, an average value for each interval that represents successive values is indicated by a linear graph for the psychophysiological response information, and a frequency value for each interval is used to form a linear graph for the recalled cognitive load because it is in a form of discrete values.

In the linear graph, an x axis indicates intervals of the learning image, and a y axis indicates an average value for each interval of each piece of the psychophysiological response information and a frequency for each interval of the recalled cognitive load.

When the learner verifies the change in recalled cognitive load for each learning interval of the learning image, a highest recalled cognitive load value is indicated in a 15th interval (75), a 16th interval (74), a fifth interval (65), and a 7th interval (59) in descending order, except start and end portions of each learning image, for example, a first interval, a 10th interval, and a 19th interval. It is because a compound proposition is explained in detail in these intervals, and cognitive load may have a high value corresponding to a high level of complexity of a learning content while the learner is acquiring new information therefrom.

In addition, a lowest recalled cognitive load value of the learner is indicated in a second interval (0), an 11th interval (3), a 3rd interval (4), and an 8th interval (13) in ascending order. It is because a learning goal or a basic concept of a learning content is explained in these intervals, and cognitive load may have a low value corresponding to a low level of complexity of such a basic learning content.

Thus, a value of recalled cognitive load may increase or decrease in proportion to a level of complexity of a learning content and a task included in the learning image.

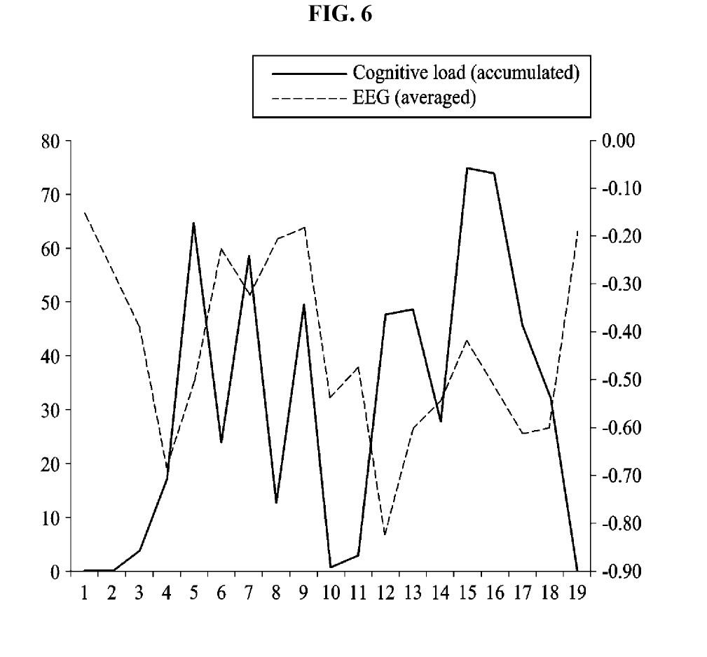

FIG. 6 is a diagram illustrating an example of a change in brainwave information for each learning interval and a change in cognitive load based on stimulated recall response information for each learning interval according to an example embodiment.

A graph of a change in brainwave information for each learning interval and a change in cognitive load of stimulated recall response information for each learning interval is illustrated. The brainwave information may be indicated in a form of a wave indicating a movement by an interaction or activity of nerve cells in a brain of a leaner, and may indicate an activated state of the brain by a gamma wave and a theta wave used for the learner to learn a learning image.

That is, the learner may activate mainly the gamma wave and the theta wave among brainwaves to recall a learning content while the learner is learning the learning image. Thus, as illustrated in the graph of FIG. 6, inflection points may be similarly indicated in some intervals between the change in recalled cognitive load in the learner and the change in brainwave information.

This may be a result from a relationship between whether a brainwave is activated or not based on a learning content and recalled cognitive load in the learner that stimulates the brain to improve an understanding of the learning content. That is, when the brainwave is activated, recalled cognitive load in the learner may increase by a high level of complexity of the learning content.

For example, referring to the graph of FIG. 6, an x axis indicates learning intervals of a learning image, and a y axis indicates a frequency of recalled cognitive load in the learning intervals of the learning image in sequential order and an average brainwave value for each learning interval. Herein, a portion in which a brainwave response of the learner and the recalled cognitive load have similar variations includes a 9th interval, a 13th interval, a 15th interval, and a 17th interval, except start and end points of learning the learning image, for example, a 1st interval, a 10th interval, and a 19th interval. In detail, among the learning intervals with the similar variations, learning intervals in which the recalled cognitive load in the learner changes to be high are the 9th interval for an existential proposition and negation, and the 13th interval and the 15th interval for examples of a compound proposition. In contrast, among the learning intervals with the similar variations, a learning interval in which the recalled cognitive load in the learner changes to be low is the 17th interval for explanation of an example of negation of the compound proposition.

In the 9th interval, the 13th interval, and the 15yh interval in which both the brainwave response and the recalled cognitive load increase, the learner may record a memo, for example, “tried to figure out why negation is came out and recalled a memory of proving a proposition through the negation” and “needed a mental effort to understand the proposition through an example,” which are explanations for marked intervals. Herein, when the learner associates a learned concept with an existing memory to learn a concept included in the learning image, or applies the learned concept to an actual case or example to learn the concept included in the learning image, cognitive load may occur in the learner and the brainwave response may thus be activated.

Thus, according to an example embodiment, as a brainwave response is activated by recalled cognitive load in a learner in response to an activated sate of a brain of the learner based on brainwave information of the learner, a working memory may be activated while the learner is performing information processing and cognitive load in the learner may occur while a goal or a concept are being explained.

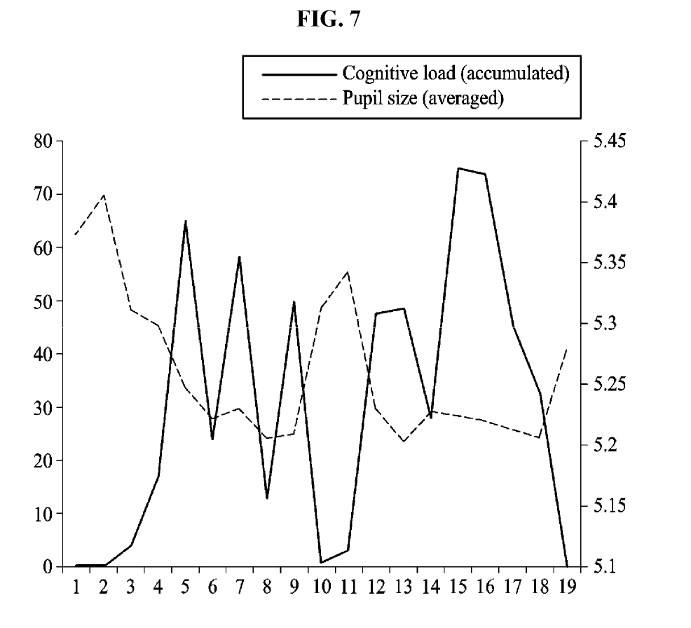

FIG. 7 is a diagram illustrating an example of a change in pupil size information for each learning interval and a change in cognitive load based on stimulated recall response information for each learning interval according to an example embodiment.

A graph of a change in pupil size information and a change in cognitive load of stimulated recall response information for each learning interval is illustrated. Herein, the pupil size information may be a result of measuring a size of a left pupil and a size of a right pupil of a learner in response to various emotions and visual stimuli.

As a pupil of the learner is dilated due to an unconscious response of the learner to a learning content, for example, due to attention to and concentration on the learning content, during a learning process, inflection points may be similarly indicated in some intervals between a change in pupil size information of the learner and a change in recalled cognitive load in the learner as illustrated in the graph of FIG. 7.

A pupil size may change based on a level of difficulty of a learning content, and may increase when cognitive load increases. Such an increase in pupil size may indicate an unconscious response from the learner occurring when the learner activates a certain memory of a learning image or a level of task complexity increases. Thus, when a pupil size of the learner increases, corresponding cognitive load may increase.

For example, referring to the graph of FIG. 7, an x axis indicates learning intervals of a learning image, and a y axis indicates a frequency of recalled cognitive load in the learning intervals of the learning image in sequential order and an average pupil size for each learning interval. Herein, a portion in which a pupil size of the learner and the recalled cognitive load have similar variations includes a 5th interval, a 7th interval, an 11th interval, a 12th interval, a 13th interval, a 14th interval, a 15th interval, and a 16th interval, except start and end points of learning of the learning image, for example, a 1st interval, a 10th interval, and a 19th interval. In these intervals, when the pupil size changes drastically to increase or decrease, the recalled cognitive load may change similarly. Among the intervals, intervals in which the recalled cognitive load in the leaner increases drastically include, in sequential order, the 5th interval for concepts of a universal proposition and an existential proposition, the 7th interval for negation of the universal proposition, the 12th and 13th intervals for a concept and an example (∀,∃) of a compound proposition, and the 15th and 16th intervals for an example (comprehensive) and negation of the compound proposition.

Thus, it is verified that, when a new concept is provided through the learning image, the recalled cognitive load in the learner is high and the change in pupil size is relatively small. In addition, it is verified that, when the learner learns the negation of the compound proposition, which is an intensified concept from a general concept of the compound proposition, the recalled cognitive load in the learner is higher or the change in pupil size is relatively small. In contrast, among the intervals in which the change in recalled cognitive load and the change in pupil size have similar variations, intervals in which the recalled cognitive load in the learner changes drastically to be less include, in sequential order, the 11th interval for a learning goal and the 14th interval for an example (∃, ∀) of the compound proposition. This is because, when the learning goal is introduced or presented or a case similar to a previously learned content is introduced or presented, the recalled cognitive load in the learner is low and the change in pupil size is high.

In addition, among the intervals in which the change in recalled cognitive load and the change in pupil size have similar variations, intervals in which the recalled cognitive load in the learner changes drastically to be great include the 5th interval, the 7th interval, the 12th interval, the 13th interval, the 15th interval, and the 16th interval, and the learner recalled that cognitive load occurs in theses intervals may record an additional memo as follows.

In the 5th interval, the 7th interval, the 12th interval, and the 16th interval that cover a concept of each proposition, the learner may record a memo, for example, “learned with a mental effort because a new content is introduced” and “was nervous and tried to listen more carefully because a new character is introduced.” Thus, as a new concept is introduced, cognitive load may occur due to the corresponding learning content. In addition, the learner may record a memo, for example, “made a mental effort because I could not remember a concept of negation” and “tried to associate it with what I learned when I was young.” Thus, from such memos, it is verified that cognitive load occurs while the learner is trying to associate a past memory with what the learner is currently learning.

Thus, according to an example embodiment, as recalled cognitive load in the learner occurs in response to the pupil size increasing, cognitive load in the learner may occur while the leaner is applying a learned concept to a case or an example and understanding an intensified concept through the applying.

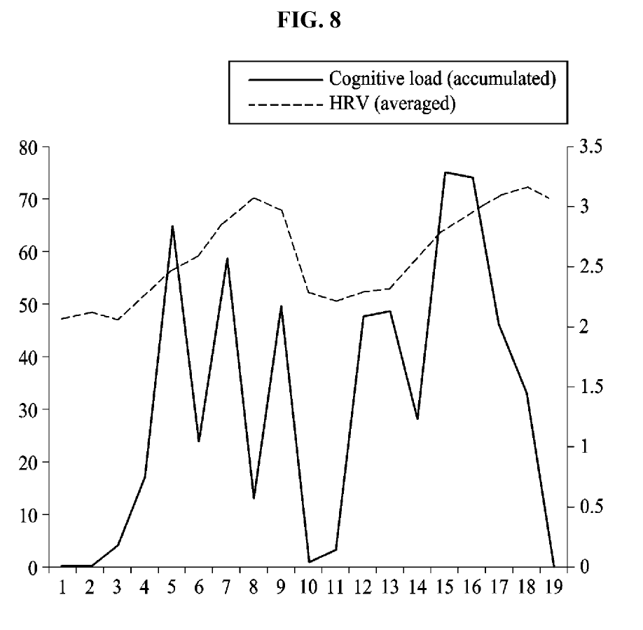

FIG. 8 is a diagram illustrating an example of a change in HRV information for each learning interval and a change in cognitive load based on stimulated recall response information for each learning interval according to an example embodiment.

A graph of a change in HRV information for each learning interval and a change in cognitive load based on stimulated recall response information for each learning interval is illustrated. Herein, the HRV information may be information measured using an ECG signal, and a heart rate and ECG, in response to an intensity of an emotion of a learner who learns a learning image.

As a pulse or a heart rate of the learner increases while the learner is learning the learning image, a heart rate interval may change by a psychological state of the learner, for example, a state in which the leaner is nervous, or embarrassed or confused. Thus, inflection points may be similarly indicated in some intervals between a change in HRV information and a change in recalled cognitive load in the learner as illustrated in the graph of FIG. 8.

For example, referring to the graph of FIG. 8, an x axis indicates learning intervals of a learning image, and a y axis indicates a frequency of recalled cognitive load in the learning intervals of the learning image in sequential order and an average HRV value for each learning interval. Herein, it is verified that the change in HRV information and the change in recalled cognitive load have similar variations in learning intervals, for example, a 7th interval, a 9th interval, a 16th interval, and a 17th interval, except start and end points of learning of the learning image, for example, a 1st interval, a 10th interval, and a 19th interval. In all the learning intervals, the recalled cognitive load in the learner changes to be high. That is, in intervals such as the 7th interval, the 9th interval, a 12th interval, and the 16th interval that cover a concept of a learning content, and the 17th interval that covers an application of an example after the concept is learned, it is verified that cognitive load in the learner increases and an HRV also increases.

In addition, the learner may record a memo, for example, “needed a mental effort to understand the meaning of the term “universal proposition,” which verifies that cognitive load occurs to understand the new term and a heart rate increases. In addition, the learner may also record an explanation in a marked interval, for example, “understood well the universal proposition, but made a mental effort to accurately determine a difference from an existential proposition” and “needed a mental effort because I needed to continue learning by distinguishing it from negation of the universal proposition that I learned previously.” Thus, it is verified that cognitive load occurs when the learner recalls a memory of what the learner previously learned and associates the recalled memory with what the learner is newly learning.

However, throughout an overall video learning interval, curves of the changes in the two variables have different patterns. The change in recalled cognitive load for each interval may have many inflection points with great variations. The change in the HRV information may tend to gradually increase after a minimum point in the first interval and the 10th interval in which a first learning image and a second learning image start, respectively.

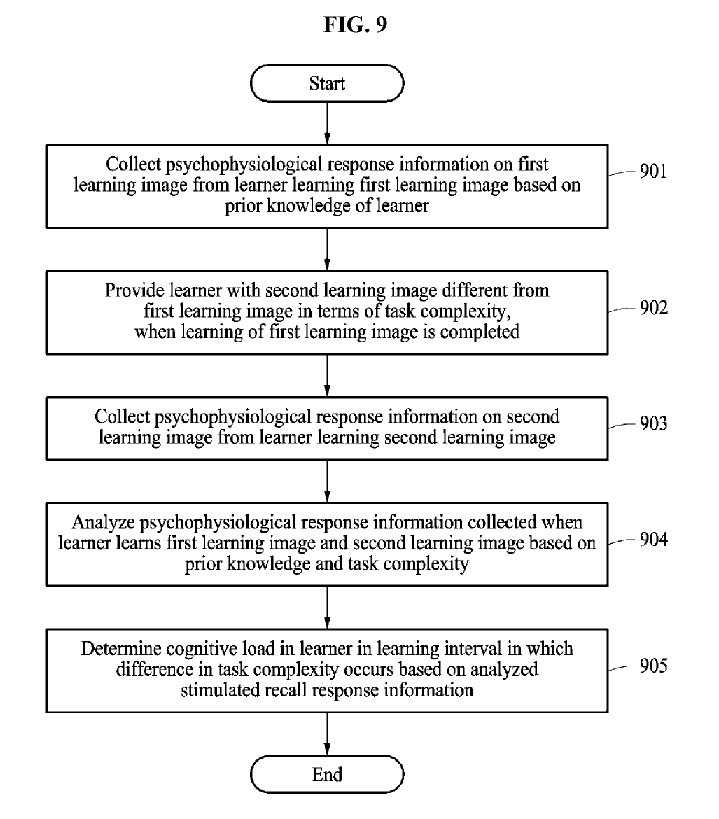

FIG. 9 is a flowchart illustrating an example of a learning situation determining method to determine cognitive load in a learner using prior knowledge and psychophysiological response information according to another example embodiment.

Referring to FIG. 9, in operation 901, a learning situation determining apparatus collects psychophysiological response information associated with a first learning image from a learner who learns the first learning image based on prior knowledge possessed by the learner. In detail, the learning situation determining apparatus may determine the prior knowledge based on a prior learning ability of the learner before the learner learns the first learning image. The learning situation determining apparatus may perform a pretest to determine how much the learner learns or understands a learning image to be learned. After performing the pretest, the learning situation determining apparatus may classify the learner into an upper group or a lower group based on the prior knowledge possessed by the learner. When a result of the pretest performed on the learner is greater than or equal to an average score of all learners who take the pretest, the learning situation determining apparatus may classify the learner into the upper group. Conversely, when the result of the preset performed on the learner is less than the average score, the learning situation determining apparatus may classify the learner into the lower group.

The learning situation determining apparatus may collect the psychophysiological response information of the learner learning the first learning image based on the prior knowledge possessed by the learner. The psychophysiological response information may include, for example, pupil size information and HRV information of the learner stimulated by the first learning image. Herein, the learning situation determining apparatus may collect psychophysiological responses from the learner to determine a behavioral change, a cognitive change, and an emotional change that occur in the learner during a learning process.

In operation 902, when the learner completes learning the first learning image, the learning situation determining apparatus provides the learner with a second learning image different from the first learning image in terms of task complexity. The learning situation determining apparatus may provide the first learning image with a relatively lower level of task complexity and then the second learning image with a relatively higher level of task complexity in sequential order to measure cognitive load in the learner based on the prior knowledge while minimizing extraneous cognitive load in the learner.

Herein, a level of task complexity of each of the first learning image and the second learning image may be determined based on an average score of all learners for each learning interval of the pretest performed on the learner before the learner learns the learning image. That is, in a case of a learning interval for which an average score obtained from the pretest performed on the learner for each learning interval is less than the average score of all the learners for each learning interval, a level of task complexity of the learning interval may be determined to be high. In a case of a learning interval for which an average score obtained from the pretest performed on the learner for each learning interval is greater than or equal to the average score of all the leaners for each learning interval, a level of task complexity of the learning interval may be determined to be low.

In operation 903, the learning situation determining apparatus collects psychophysiological response information associated with the second learning image from the learner who learns the second learning image. The learning situation determining apparatus may collect the psychophysiological response information of the learner who is learning the second learning image with a relatively higher level of task complexity than that of the first learning image.

In operation 904, the learning situation determining apparatus analyzes the psychophysiological response information collected when the learner learns the first learning image and the second learning image based on the prior knowledge and the task complexity. The learning situation determining apparatus may classify learning intervals in the first learning image and the second learning image into a learning interval with a high level of task complexity and a learning interval with a low level of task complexity. The learning situation determining apparatus may determine the psychophysiological response information of the learner for each of the learning interval with the high level of task complexity and the learning interval with the low level of task complexity.

The learning situation determining apparatus may analyze the psychophysiological response information that changes based on each time point at which the first learning image and the second learning image proceed. Herein, when a level of task difficulty based on a level of task complexity increases, a pupil size of the learner may increase and the pupil size information of the learner may increase accordingly. When the level of task complexity increases, the level of task difficulty in learning a learning content may increase proportionally. Herein, the level of task or learning difficulty may vary based on prior knowledge possessed by a learner.

For example, although the level of learning difficulty increases, a learner having a relatively higher level of prior knowledge may use a relatively less amount of time to acquire a learning content based on the prior knowledge that the learner is previously obtained, compared to a learner having a relatively lower level of prior knowledge. That is, the learner with the relatively higher level of prior knowledge may have a relatively higher level of awareness of the learning content, compared to the learner with the relatively lower level of prior knowledge. Thus, psychophysiological response information may be used to determine whether cognitive load occurs in a learner in response to a learning content.

The learning situation determining apparatus may analyze the psychophysiological response information of the leaner to verify cognitive load occurring in the learner while the learner is learning the learning image based on the prior knowledge and the task complexity.

In operation 905, the learning situation determining apparatus determines cognitive load in the learner in a learning interval in which a difference in task complexity occurs based on the analyzed psychophysiological response information. Herein, the learner may have different levels of awareness based on task complexity of the learning image, based on the prior knowledge possessed by the learner. That is, under an assumption that a capacity of available knowledge to be acquired by the learner is 100%, cognitive load, for example, germane cognitive load, extraneous cognitive load, and intrinsic cognitive load, may occur in the learner during a learning process based on the prior knowledge that is previously acquired by the learner.
The intrinsic cognitive load may be determined by a level of interaction among elements included in information, and occur by task complexity of a learning content. The intrinsic cognitive load may increase when intrinsic information of the learning content is complex or information is presented extremely fast, and a frequency of occurrence of the cognitive load may vary based on prior knowledge or an experience level of a learner. Thus, when a same learning image is given, a learner possessing a greater amount of prior knowledge may experience a relatively low level of intrinsic cognitive load. In contrast, a learner possessing a less amount of prior knowledge may experience a relatively high level of intrinsic cognitive load although the learning image has a relatively low level of task complexity.
The extraneous cognitive load may be unnecessary cognitive load occurring by a type and a method of presenting a learning material, and information that is not related to learning.
The germane cognitive load may be cognitive load occurring from a mental effort involved in learning to solve a question or a problem given to a learner while the learner is integrating prior knowledge and new information to understand the new information. The germane cognitive load may occur while the learner is solving a learning task of a learning content to achieve a good result from the learning task.

The intrinsic cognitive load may occur by task complexity of a learning content, and the germane cognitive load may occur during a cognitive process of a learner in response to a learning content. According to an example embodiment, it is possible to determine whether cognitive load occurs for each learning interval of a learning image by analyzing a change in pupil size information and psychophysiological response information as an unconscious or conscious behavior or response to the cognitive load occurring while the learner is learning the learning image.

In addition, by verifying whether cognitive load occurs or not by classifying the learner into the upper group or the lower group based on the prior knowledge possessed by the learner, it is possible to more accurately verify a level of cognitive load and an interval in which the cognitive load occurs based on the prior knowledge possessed by the learner. Based on this, it is possible to systematically provide a learning plan suitable for each level.

In detail, it is possible to determine whether cognitive load occurs in a learner during a learning process based on Table 2 below.

TABLE 2

| | | |
|---|---|---|
| First type | Second type | High level of |
| (High level of task | (Low level of task | cognitive load |
| complexity/high level of | complexity/high level of | |
| cognitive load) | cognitive load) | |
| Third type | Fourth type | Low level of |
| (High level of task | (Low level of task | cognitive load |
| complexity/low level of | complexity/low level of | |
| cognitive load) | cognitive load) | |
| High level of task complexity | Low level of task | |
| | complexity | |

According to an example embodiment, it is possible to determine a cognitive load state of a leaner for each interval by classifying types of occurrence of cognitive load. By referring to Table 2 above, in the first type and the fourth type, a level of task complexity may correspond to a level of cognitive load. The second type may occur when the learner experiences unnecessary extraneous cognitive load. The third type may occur when the learner fails to concentrate on learning.

In detail, the first type may indicate an interval with a high level of task complexity and a high level of cognitive load, and whether the learner learns the interval properly. Thus, an additional real-time prescription for pushing a learning process may not be provided.

The fourth type may indicate an interval with a low level of task complexity and a low level of cognitive load, and that the learner may have a low level of cognitive load in an interval with a low level of task complexity. This may be a general situation occurring to learners who learn a learning image, and thus an additional prescription for pushing a learning process may not be provided.

The second type may indicate a state in which the learner may experience a high level of cognitive load despite a low level of task complexity. Herein, in a case of a learner having a high level of prior knowledge, this state may indicate that additional extraneous cognitive load occurs in the learner due to unnecessary learning. Conversely, in a case of a learner having a low level of prior knowledge, this state may indicate that extraneous cognitive load occurs for the same reason applied to the learner having a high level of prior knowledge, or that a subjective level of task complexity is not that low for the learner although an objective level of task complexity is low.

Thus, an option of passing the corresponding learning interval and continuing learning may be assigned to the learner having a high level of prior knowledge. The learner having a low level of prior knowledge may be allowed to choose whether to pass the corresponding learning interval and continue learning, or learn a supplementary learning material and continue learning the corresponding learning interval.

The third type may indicate a state in which a level of cognitive load is low although a level of task complexity is high, and the learner may not properly concentrate on learning. This situation may occur when the learner may have a difficulty in concentrating on the learning due to a high level of task complexity of the corresponding learning interval, or the learning is not properly performed because a content of the corresponding learning interval is difficult to understand.

Thus, in such a situation, both the learners having a high level of prior knowledge and a low level of prior knowledge may be allowed to choose whether to learn a supplementary learning material and continue learning from a subsequent learning interval, and to move on to the subsequent learning interval after completing supplementary learning, as needed.

After learning is completed, such type information of individual leaners corresponding to the second type and the third type may be automatically sent to an online learning tutor such that an instructional support suitable for each individual learner is provided.

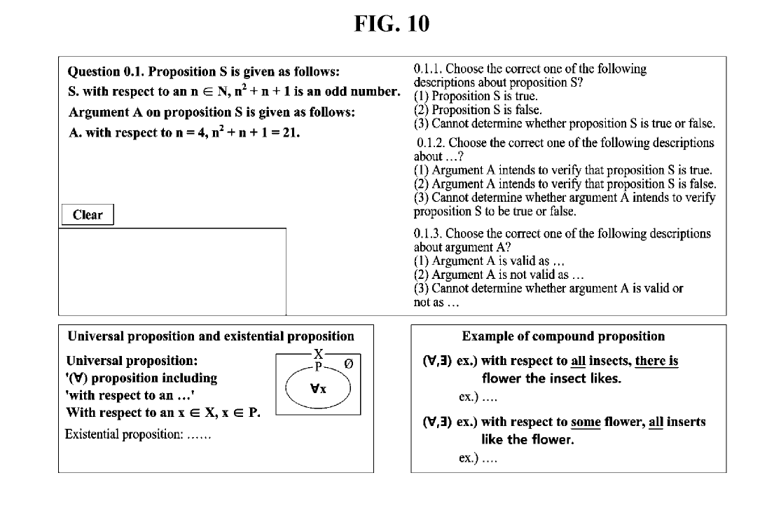

FIG. 10 is a diagram illustrating an example of how prior knowledge and psychophysiological response information of a learner are collected according to another example embodiment.

Referring to FIG. 10, a learning situation determining apparatus may provide a question of a test to evaluate prior knowledge possessed by a learner. In detail, the learning situation determining apparatus may determine the prior knowledge based on a resource that is previously formed by the leaner to solve a task of a learning content of a learning image. The prior knowledge may be defined as a schema that the learner has in association with learning contents in a same context, and be formed based on a topic of a learning content of the learning image. That is, the prior knowledge may be a starting point behavior that the learner needs to have in advance, and be a criterion to be used to determine whether the learner understands a structure or characteristic of a learning content of the learning image.

For example, the prior knowledge may be applied to a process of processing learning contents collected through the learning image, and indicate how much of the learning contents the learner has already known or how much of the learning contents the learner has already learned. The learning situation determining apparatus may determine the prior knowledge associated with a learning content of the learning image to be learned by the learner, from among various pieces of knowledge accumulated by the learner.

The learning situation determining apparatus may provide the learner with a pretest including questions to determine the accumulated knowledge of the learner. The questions may be provided at different levels of difficulty, and different scores may be set to the questions based on the levels of difficulty. The pretest may be performed before the learning image proceeds, and include questions based on a learning content of each of a first learning image and a second learning image. For example, as illustrated, the first learning image may include a learning interval for a universal proposition and an existential proposition, and the second learning image may include a learning interval for a compound proposition which is a mathematical proposition. In the illustrated example, a pretest including a total of 16 questions of which 8 questions are provided for each learning interval may be provided to a learner.

The learning situation determining apparatus may determine a level of prior knowledge possessed by the learner based on a result of the pretest, for example, a test score. The learning situation determining apparatus may classify the learner into an upper group or a lower group based on the determined level of prior knowledge.

For example, under an assumption that a total score of the pretest is 100 points, the learning situation determining apparatus may classify the learner into the lower group when the learner obtains a score of less than 50 points from the pretest, and into the upper group when the learner obtains a score of greater than or equal to 50 points from the pretest.

Referring to a left-side lower portion of FIG. 10, when the pretest is completed, the learning situation determining apparatus may play the first learning image and a screen may be changed from the pretest. Herein, the first learning image may be provided to verify an overall tendency of cognitive load experienced by the learner in a learning process, and include a learning content with a relatively lower level of task complexity than that of the second learning image.

The learning situation determining apparatus may collect pupil size information and HRV information of the learner learning the first learning image. Herein, based on a group into which the learner is classified through the pretest, the learning situation determining apparatus may collect psychophysiological response information that changes during the learning process.

Referring to a right-side lower portion of FIG. 10, when the learning of the first learning image is completed, the learning situation determining apparatus may provide the learner with the second learning image that is different from the first learning image in terms of task complexity. The learning situation determining apparatus may collect, from the learner learning the second learning image, psychophysiological response information including pupil size information and HRV information of the learner in response to the second learning image.

The pupil size information may change when a sensory event, a mental event, or an emotional event occurs irrespective of an illumination, a visual image, and a distance from a retina. Herein, dilation of a pupil of the learner may be a response by sympathetic nerves, and contraction of the pupil may be a response by parasympathetic nerves. The dilation of the pupil may reflect a cognitive process of a human psychological activity, and an increase in the pupil size information may be construed as occurrence of a mental workload during the cognitive process.

A pupil size may be calculated as a value indicating a change in pupil size from a pupil size in a basic response interval to a pupil size at a current measurement point. The pupil size information may be used herein as an indicator indicating a total amount of cognitive load experienced by the learner. When the pupil size increases greatly compared to that in the basic response interval, it is verified that cognitive load increases.

The HRV information may be a measured value of an HRV, and the HRV may indicate physiological adaptability of a human body in response to a stimulus, for example, a learning image, and be an element used to evaluate a change in autonomic nervous system. The physiological adaptability may indicate that a heart tends to rapidly respond to and adapt to a stimulus, for example, a learning image. As the element, sympathetic and parasympathetic nerves may be used. A ratio between the sympathetic nerves and the parasympathetic nerves, or an LF/HF ratio, may be used to verify a level of awareness, or awakening, of the learner in a learning environment. Herein, an LF may indicate a degree of activation by the sympathetic nerves, and the sympathetic nerves may be activated by awareness, stress, excitement, and the like of the learner. An HF may indicate a degree of activation by the parasympathetic nerves, and the parasympathetic nerves may be activated by relaxation, stability, drowsiness, and the like of the learner.

When an indicator value of the LF/HF ratio increases, it may be verified that the sympathetic nerves are relatively more activated than the parasympathetic nerves. When an indicator value based on a level of awareness in a learning environment increases, it is verified that the learner is more aware of a learning content.

Thus, according to an example embodiment, it is possible to more reliably determine whether cognitive load occurs in a learner by using psychophysiological response information based on pupil size information and HRV information indicating physical characteristics of the learner that change in a learning environment.

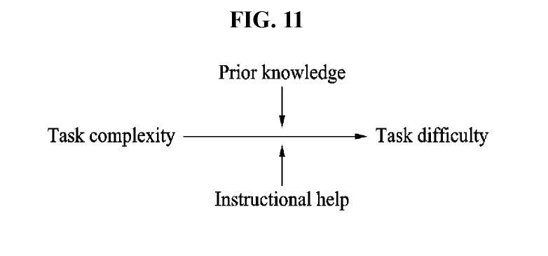

FIG. 11 is a diagram illustrating an example of a correlation between prior knowledge and task complexity according to another example embodiment.

Referring to FIG. 11, a learning situation determining apparatus may consider task complexity of a learning image and an instructional help to verify cognitive load in a learner. Herein, the task complexity and the instructional help may be considered based on an expertise, or prior knowledge, for performance of the learner.

When the learner learns the learning image, cognitive load may occur while the learner is acquiring a new content based on a level of task difficulty. That is, in a case of an extremely high level of task difficulty of the learning image, the learner may have a difficulty in learning the learning image because interaction between a learning content required to solve a corresponding task and a previously memorized learning content is beyond a working memory capacity of the learner. Conversely, in a case of an extremely low level of task difficulty, the learner may not challenge to learn the learning image because an extremely low level of intrinsic cognitive load, compared to the working memory capacity of the learner, may occur to solve a corresponding task.

In addition, the expertise of the learner, the task complexity, and the instructional help may affect such a task difficulty to be experienced by the learner to solve a task. Herein, the task complexity may be a concept encompassing everything that is to be learned through prior knowledge or through learning, and be associated with a concept and procedure related to a learning content and with elements of learning and the number of interactive elements.

In detail, the task complexity may be highly associated with intrinsic cognitive load because elements included in a task highly interact with one another. Thus, a learning interval of the learning image that includes many elements needed to be understood or many information needed to be processed simultaneously may be defined as a learning interval with a high level of task complexity. An analysis may then be performed by classifying learning intervals into a learning interval with a high level of task complexity and a learning interval with a low level of task complexity based on a defined standard.

The interactive elements may have a logical association of which a meaning may be determined when the elements are processed simultaneously in a working memory. Herein, one element may indicate one to be processed, and the elements may indicate a schema. However, when individual elements that interact with one another are not formed as a schema, a learning material with a high level of element-interactivity may need a greater amount of working memory resources, compared to a learning material with a low level of element-interactivity.

In addition, in terms of task complexity of a task in the learning image, it is not a learning content, but prior knowledge, or an expertise, of the learner, that affects intrinsic cognitive load. That is, when a same task is given to learners, intrinsic cognitive load may occur in a leaner with a low level of prior knowledge or expertise due to an increased level of element-interactivity. Conversely, intrinsic cognitive load may not occur in a learner with a high level of prior knowledge or expertise.

Thus, a level of task complexity may vary based on prior knowledge-based element-interactivity, and thus a series of many interactive learning elements for a learner with a low level of prior knowledge may be perceived as a single element for a learner with a high level of prior knowledge.

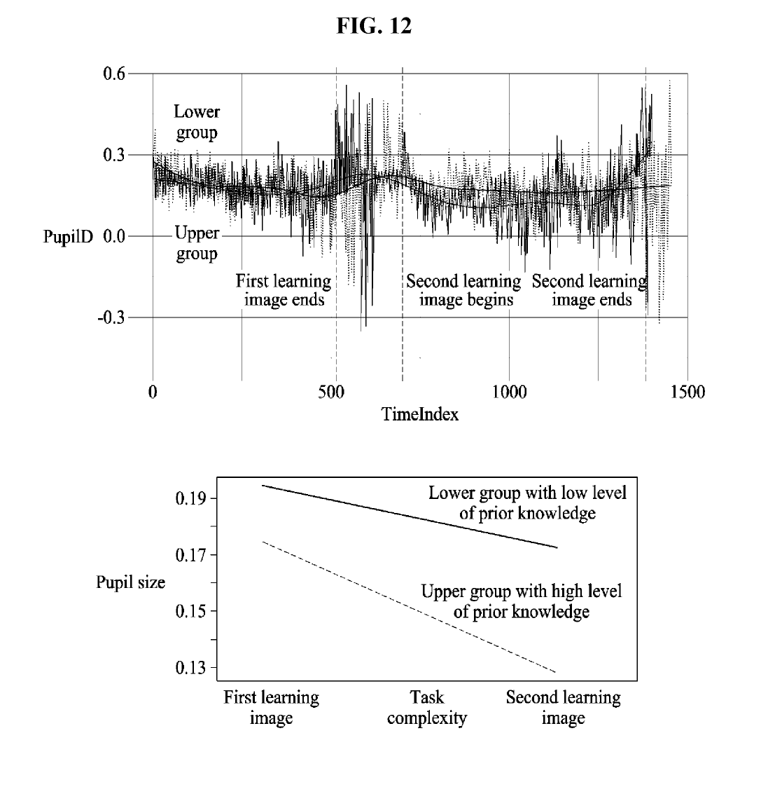

FIG. 12 is a diagram illustrating an example of a change in pupil size information of psychophysiological response information of a learner based on prior knowledge possessed by the learner according to another example embodiment.

Referring to FIG. 12, a learning situation determining apparatus may verify a tendency of cognitive load in a learner that changes while the learner is learning a learning image. The learning situation determining apparatus may extract pupil size information of learners who are classified into an upper group and a lower group based on their prior knowledge, and verify a graph using an average line of the extracted pupil size information and a level of awareness based on the graph.

In detail, the learning situation determining apparatus may classify the learners into the upper group or the lower group based on prior knowledge possessed by each of the learners before the learners learn the learning image. The learning situation determining apparatus may indicate, by a graph illustrated in an upper portion of FIG. 12, a change in pupil size information of the learners during a learning process for each of the learners in the groups.

In the graph of FIG. 12, a learning interval dividing a first learning image and a second learning image is indicated by a bolded broken line at a center. A portion of the graph on a left side from the bolded broken line, or a time index, may indicate a change in pupil size information of the learners in an interval in which the first learning image is played. A portion of the graph on a right side from the bolded broken line may indicate a change in pupil size information of the learners in an interval in which the second learning image is played.

In the graph, a broken line indicated in a latter portion of learning intervals of the first learning image and a broken line indicated in a latter potion of learning intervals of the second learning image may indicate a total playing time of the first learning image and a total playing time of the second learning image, respectively. A portion of the first learning image after the broken line and a portion of the second learning image after the broken line may indicate pupil size information of the learners who additionally learn the learning images after the set playing times elapse, or at times after the learning images are completely played.

To more intuitively illustrate the pupil size information that changes based on the prior knowledge and the task complexity of the learners, a circle average line may be smoothed to be indicated again at the center.

Although, in the graph of the pupil size information illustrated in FIG. 12, a width difference between the upper group and the lower group is not significantly indicated, it may be verified that a lower average line is indicated for the learners belonging to the upper group. For a learner having a low level of prior knowledge of a learning image with a same level of task complexity, more elements of the learning image may need to be understood and more information may need to be processed simultaneously, and thus pupil size information of the learner may increase as a psychological change. For a learner having a high level of prior knowledge of the learning image with the same level of task complexity, relatively less elements of the learning image may need to be understood and relatively less information may need to be processed, compared to the learner having the low level of prior knowledge, and thus pupil size information of the learner may decrease.

That is, the upper group including learners having a high level of prior knowledge may show the lower average line of pupil size information, compared to an average line of pupil size information measured from the lower group including leaners having a low level of prior knowledge. This is more clearly shown in intervals in which the second learning image with a higher level of task complexity than the first learning image is played. In the intervals in which the first learning image is played, an average line has a small width of difference between the upper group and the lower group in pupil size information throughout an overall learning process. In the intervals in which the second learning image is played, the lower group may show an average line that is almost straight.

The learning situation determining apparatus may determine a difference between the pupil size information of the upper group and the pupil size information of the lower group in the learning intervals of the first learning image with a relatively lower level of task complexity and in the learning intervals of the second learning image with a relatively higher level of task complexity. The learning situation determining apparatus may calculate, for each of the upper group and the lower group, an average value of pupil size information in the learning intervals of the first learning image and the learning intervals of the second learning image. In addition, the learning situation determining apparatus may verify a difference between the calculated average values of the pupil size information of the upper group and the pupil size information of the lower group.

For example, to more intuitively verify a difference in pupil size based on a level of prior knowledge on a first learning image for a universal proposition and an existential proposition that includes a learning interval with a low level of task complexity and on a level of prior knowledge on a second learning image for a compound proposition, a graph that compares averages is illustrated in a lower portion of FIG. 12.

The average value of the pupil size information of the upper group may be less than that of the pupil size information of the lower group in each learning interval of the first learning image and the second learning image. In addition, the difference between the pupil size information of the upper group and the pupil size information of the lower group may be greater in learning intervals of the second learning image.

Thus, although a level of task complexity increases, a learner belonging to the upper group with a high level of prior knowledge may more stably learn a learning image, compared to a learner belonging to the lower group with a low level of prior knowledge.

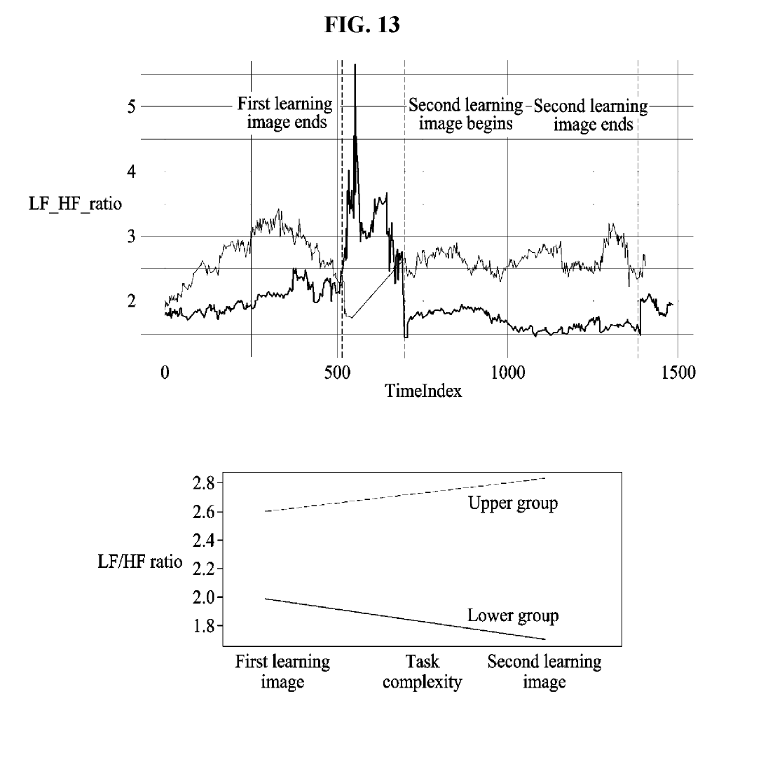

FIG. 13 is a diagram illustrating an example of a change in HRV information of psychophysiological response information of a learner based on prior knowledge possessed by the learner according to another example embodiment.

Referring to FIG. 13, it is possible to verify a graph including average lines of HRV information of an upper group and a lower group that are classified based on a level of prior knowledge possessed by learners and verify a corresponding level of awareness, to verify a tendency of cognitive load in a learner that changes during a learning process. Before the learner learns a learning image, a learning situation determining apparatus may classify the learner into the upper group or the lower group based on a level of prior knowledge possessed by the learner. In addition, the learning situation determining apparatus may indicate a change in HRV information of each of the classified groups during a learning process, as illustrated in a graph in an upper portion of FIG. 13.

The graph of FIG. 13 illustrates an average line for each of the upper group and the lower group that are classified based on prior knowledge, using an HRV, for example, a change in ratio between sympathetic nerves and parasympathetic nerves (an LF/HF ratio). Referring to the graph, throughout a first learning image and a second learning image, the LF/HF ratio is maintained relatively highly in the upper group, compared to the lower group.

For example, for a learner belonging to the upper group, an LF/HF ratio increases gradually in the beginning of the first learning image for a universal proposition and an existential proposition and then decreases. For a learner belonging to the lower group, an LF/HF ratio increases moderately. In learning intervals of the first learning image with a low level of task complexity, learners may already know contents in the learning intervals, and the lower group may have continuously low values on such a moderate rise as time elapses. Conversely, the upper group may have an HRV value that increases in the beginning of learning and then rapidly decreases after the middle of the learning, and have continuously high values in a learning interval with a high level of task complexity.

A difference between the HRV information of the upper group and the HRV information of the lower group may become greater during a learning process of the second learning image. A learner belonging to the upper group may maintain a stable state because as HRV information decreases considerably because the learner understands well a learning content of a learning image when the learning image proceeds. In contrast, a learner belonging to the lower group may have a difficulty in understanding the learning content when the learning image proceeds, and thus HRV information of the learner may have a high, yet moderate, ratio.

In a graph illustrated in a lower portion of FIG. 13, a change in the LF/HF ratio of the upper group and a change in the LF/HF ratio of the lower group is more intuitively illustrated.

The graph indicates a comparison of average values to more intuitively illustrate a difference between HRV information of the upper group and HRV information of the lower group, in learning intervals of the first learning image with a low level of task complexity for a universal proposition and an existential proposition and learning intervals of the second learning image with a high level of task complexity for a compound proposition.

In all the learning intervals of the first learning image and the second learning image, the upper group with a high level of prior knowledge may have a relatively higher LF/HF ratio, compared to the lower group with a low level of prior knowledge. In addition, in the learning intervals of the second learning image, a difference between the LF/HF ratio of the upper group and the LF/HF ratio of the lower group may become greater.

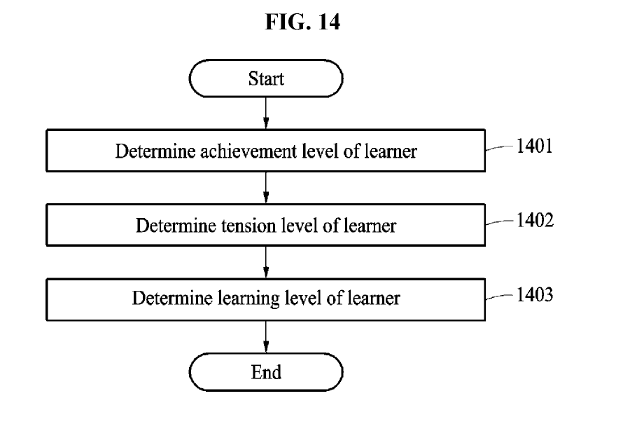

FIG. 14 is a flowchart illustrating an example of a process of determining a learning level of a learner according to an example embodiment.

In operation 1401, a learning situation determining apparatus determines an achievement level of a learner based on whether an answer, or a response, to a question from the learner is correct or incorrect. For example, when a response to a question from the learner is correct, the learning situation determining apparatus may determine the achievement level of the learner to be high. Conversely, when a response to the question from the learner is incorrect, the learning situation determining apparatus may determine the achievement level of the learner to be low.

For example, in a case in which a plurality of questions is included in a test, the learning situation determining apparatus may determine the achievement level of the learner to be high when the learner obtains, from the test, a score greater than a predetermined threshold score. In a case in which there is a plurality of learners who takes the test, the learning situation determining apparatus may determine, to be high, an achievement level of a learner who obtains a score greater than an average score of all the learners, or a score in top n % in which n denotes a real number. The learning situation determining apparatus may determine an achievement level of a learner to be low, otherwise.

In operation 1402, the learning situation determining apparatus determines a tension level of the learner based on psychophysiological response information of the learner that is obtained while the learner is responding to the question. The learning situation determining apparatus may determine the tension level of the learner based on the psychophysiological response information which is based on at least one of a skin conductance response based on an amount of sweat in a hand of the learner that perspires while the learner is responding to the question, HRV information measured while the learner is responding to the question based on a heart period variability of the learner, or a skin temperature of the learner that changes while the learner is responding to the question.

For example, when the skin conductance response of the leaner measured while the learner is responding to the question is greater than a preset first threshold value, the learning situation determining apparatus may determine the tension level of the learner to be high, or to be low otherwise. For another example, when the HRV information of the learner obtained while the learner is responding to the question is greater than a preset second threshold value, the learning situation determining apparatus may determine the tension level of the learner to be high, or to be low otherwise. For still another example, when the skin temperature of the learner measured while the learner is responding to the question is less than a preset third threshold value, the learning situation determining apparatus may determine the tension level of the learner to be high, or to be low otherwise. Alternatively, the learning situation determining apparatus may determine the tension level of the learner based on a combination of the skin conductance response, the HRV information, and the skin temperature.

According to an example embodiment, the learning situation determining apparatus may determine the tension level of the learner by comparing a basic response, which is an ordinary response from the learner, of the psychophysiological response information to a response from the learner in an interval in which the learner responds to each question.

The basic response of the learner, which is indicated as an ordinary response value, may be generated for each type of psychophysiological response information by measuring a skin conductance response, HRV information, and a skin temperature of the learner while a blank screen and calming music are being provided to the learner before the test. A basic response value of each type of psychophysiological response information may be generated as illustrated in Table 3 below.

TABLE 3

| | | Skin | Skin |
|---|---|---|---|
| | HRV | response | temperature |
| Basic response of psychophysiological | 44.3 | 3.4 | 36.5 |
| response information | | | |

Subsequently, during the test, an average value of each type of psychophysiological response information corresponding to an interval in which a response to each question is provided may be generated. For example, when a total of 10 seconds is used for the learner if) to solve question 1, the learning situation determining apparatus may measure an HRV, a skin response, and a skin temperature of the learner for the 10 seconds, and calculate an average value of each type of psychophysiological response information measured for the 10 seconds. An average value of each type of psychophysiological response information may be generated as illustrated in Table 4 below.

TABLE 4

| Difference between physiological data | | Skin | Skin |
|---|---|---|---|
| and basic response to each question | HRV | response | temperature |
| Question 1 | 44.1 | 3.3 | 36.5 |
| Question 2 | 45.2 | 3.8 | 36.4 |
| Question 3 | 44.8 | 3.5 | 36.5 |

Herein, when average values of the skin conductance response and the HRV information are greater than corresponding basic response values, and an average value of the skin temperature is less than a corresponding basic response value, the learning situation determining apparatus may determine the tension level to be high based on each type of psychophysiological response information. When the average values of the skin conductance response and the HRV information are less than or equal to the corresponding basic response values, and the average value of the skin temperature is greater than or equal to the corresponding basic response value, the learning situation determining apparatus may determine the tension level to be low based on each type of psychophysiological response information. The tension level may be determined as illustrated in Table 5 below.

TABLE 5

| Difference between basic response and | | Skin | Skin |
|---|---|---|---|
| data for each question | HRV | response | temperature |
| Question 1 | Low | Low | Low |
| Question 2 | High | High | High |
| Question 3 | High | High | Low |

Subsequently, when a majority of respective tension levels related to each of the questions based on each type of psychophysiological response information is determined to be high, the learning situation determining apparatus may determine a final tension level to be high. Conversely, when the majority of the tension levels related to each of the questions based on each type of psychophysiological response information is determined to be low, the learning situation determining apparatus may determine the final tension level to be low. The final tension level may be determined as illustrated in Table 6 below.

TABLE 6

| Difference | | | | | |
|---|---|---|---|---|---|
| between basic | | | | | Final |
| response and data | | Skin | Skin | | tension |
| for each question | HRV | response | temperature | Majority | level |
| Question 1 | Low | Low | Low | Less than | Low |
| | | | | or equal | |
| Question 2 | High | High | High | Exceed | High |
| Question 3 | High | High | Low | Exceed | High |

The learning situation determining apparatus may use, as psychophysiological response information, or psychophysiological data, at least one of an average value of skin conductance response values measured in response to the questions based on an amount of sweat shed from a hand of the learner who responds to the questions, an average value of HRV values measured in response to the questions based on an HRV of the learner, or an average value of skin temperatures measured, in response to the question, from a middle finger that is not frequently used. The learning situation determining apparatus may compare the average values of the three types of psychophysiological response information to the corresponding basic response values to determine whether a tension level of the learner that is related to each of the questions is high or low.

The learning situation determining apparatus may determine a type of tension felt by the learner based on whether a response to a question from the learner is correct or incorrect. For example, when the response to the question from the learner is correct, the learning situation determining apparatus may determine a type of tension to be concentration. When the response to the question from the learner is incorrect, the learning situation determining apparatus may determine a type of tension to be anxiety.

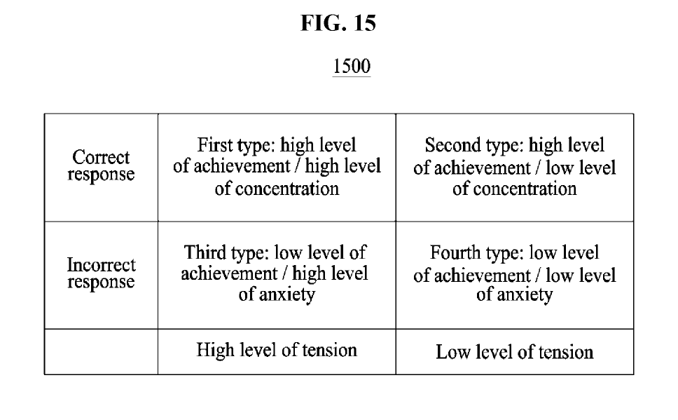

In operation 1403, the learning situation determining apparatus determines a learning level of the learner based on the achievement level and the tension level of the learner. For example, the learning situation determining apparatus may determine the learning level of the learner to be one of three types based on the achievement level and the tension level. How the learning level is determined will be described hereinafter with reference to FIG. 15.

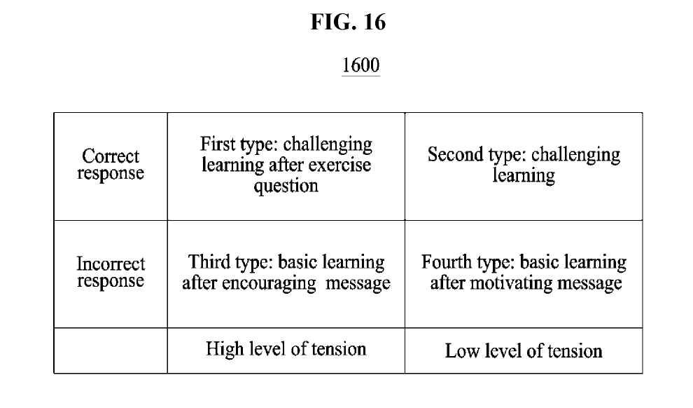

Although not illustrated in FIG. 14, the learning situation determining apparatus may provide the learner with follow-up learning determined based on the determined learning level. How the follow-up learning is provided to a learner will be described hereinafter with reference to FIG. 16.

FIG. 15 is a diagram illustrating examples of types of learning level according to an example embodiment.

FIG. 15 illustrates a table 1500 indicating three types of learning level according to an example embodiment.

Referring to the table 1500, there are three types of learning level that are determined based on an achievement level and a tension level of a learner. A learning level of the learner may be determined to be one of the three types.

According to an example embodiment, psychophysiological response information may indicate a tension level of a learner that indicates tension felt by the learner based on a level of difficulty of a question and a level of prior learning of the learner. The tension of the learner may be indicated as concentration or immersion that helps the learner for learning, or as anxiety or nervousness that inhibits the learner from learning.

For example, when a response to a question from the learner is correct, the achievement level of the learner may be determined to be high. In this example, when the tension level is high, a level of concentration or immersion of the learner may be determined to be high. Since the high level of achievement is acquired by the high level of concentration, a learning situation determining apparatus may determine the learning level of the learner to be a first type of learning level at which the learner may solve the question with knowledge of a learning content related to the question and the high level of concentration, and great effort.

For example, when a response to a question from the learner is correct, the achievement level of the learner may be determined to be high. In this example, when the tension level of the learner is low, a level of concentration or immersion of the learner may be determined to be low. Since the high level of achievement is acquired despite the low level of concentration, the learning situation determining apparatus may determine the learning level of the learner to be a second type of learning level at which the learner may solve the question with a high level of expertise in a learning content related to the question and familiarity with the learning content, and less effort.

For example, when a response to a question from the learner is incorrect, the achievement level of the learner may be determined to be low. In this example, when the tension level of the learner is high, a level of anxiety of the learner may be determined to be high. Since the low level of achievement is acquired with the high level of anxiety, the learning situation determining apparatus may determine the learning level of the learner to be a third type of learning level at which the learner may not exhibit his/her ability due to anxiety although the learner wants to solve the question.

For example, when a response to a question from the learner is incorrect, the achievement level of the learner may be determined to be low. In this example, when the tension level of the learner is low, a level of anxiety of the learner may be determined to be low. Since the learner feels the low level of anxiety and acquires the low level of achievement, the learning situation determining apparatus may determine the learning level of the learner to be a fourth type of learning level at which the learner may pay less attention and make less effort to solve the question.

FIG. 16 is a diagram illustrating examples of types of follow-up learning provided based on a learning level of a learner according to an example embodiment.

FIG. 16 illustrates a table 1600 indicating three types of follow-up learning provided based on a learning level of a learner according to an example embodiment.

According to an example embodiment, a learning situation determining apparatus may provide a learner with follow-up learning suitable to a learning level of the learner.

For example, the learning situation determining apparatus may provide, to a learner with a first type of learning level, once more an exercise question of a learning content related to a question such that the learner becomes familiar with the learning content and improves expertise in the learning content, and then provide the learner with challenging learning, for example, a learning content with a higher level of difficulty.

For example, the learning situation determining apparatus may provide, to a learner with a second type of learning level, a learning content with a higher and more challenging difficulty, compared to a level of difficulty of the learning content related to the corresponding question.

For example, the learning situation determining apparatus may provide, to a learner with a third type of learning level, an encouraging message and an option for follow-up learning. In this example, the learning situation determining apparatus may provide the encouraging message for learning such that the learner with the third type of learning level may relieve anxiety, and then provide the option for follow-up learning such that the learner may choose one between the learning content related to the question and a more fundamental learning content rather than the learning content related to the question.

For example, the learning situation determining apparatus may provide, to a learner with a fourth type of learning level, a motivating message and an option for follow-up learning. In this example, the learning situation determining apparatus may provide the motivating message to the learner such that the learner may have an interest in learning and feel the necessity of learning, and then provide the option for follow-up learning such that the learner may choose one between the learning content related to the question and a more fundamental learning content rather than the learning content related to the question.

For example, when a learner fails to fully exhibit his/her ability due to cognitive load occurring due to a high level of anxiety felt by the learner during a test after learning, the learner may receive a lower score from the test for the original ability of the learner, and may experience a vicious circle with an increased level of anxiety. For another example, among learners who acquire a high level of achievement from a test, a learner who already acquires a high level of expertise and is not that anxious about the test and a learner who is very anxious about the test to apply knowledge to a question to solve the question may have different learning levels, and thus different types of follow-up learning may need to be designed for these learners with the different learning levels. Thus, according to an example embodiment, it is possible to determine a learning level of a learner to be one of three types of learning level based on an achievement level and a tension level of the learner, and effectively provide the learner with follow-up learning suitable to the determined learning level.

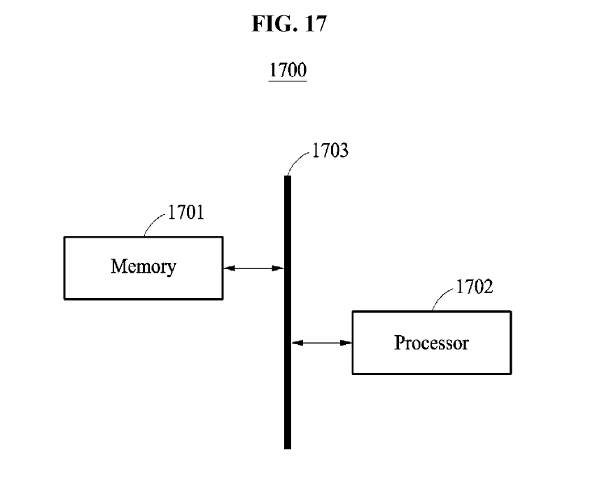

FIG. 17 is a diagram illustrating an example of a learning situation determining apparatus according to an example embodiment.

Referring to FIG. 17, a learning situation determining apparatus 1700 includes a memory 1701 and a processor 1702. The memory 1701 and the processor 1702 may communicate with each other through a bus 1703.

The memory 1701 may include a computer-readable instruction. When the instruction stored in the memory 1701 is executed, the processor 1702 may perform the operations described above. The memory 1701 may be a volatile or nonvolatile memory.

The processor 1702 may execute instructions or programs. The learning situation determining apparatus 1700 may be embodied as various computing apparatuses or devices, such as, for example, a personal computer (PC), a tablet computer, and a netbook, or as a portion of various computing apparatuses or devices, such as, for example, a mobile phone, a smartphone, a personal digital assistant (PDA), a tablet computer, and a laptop computer.

The processor 1702 may collect psychophysiological response information to determine a change in psychological state and a physiological state of a learner who learns a first learning image. When the learning of the first learning image is completed, the processor 1702 may play a second learning image including a same learning content as that of the first learning image for which the learning is completed, and collect stimulated recall response information marked on the second learning image in response to a stimulated recall of the learner learning the second learning image and then determine cognitive load in the learner that is recalled from the first learning image using the psychophysiological response information and the stimulated recall response information.

The processor 1702 may collect, from a learner who learns a first learning image, psychophysiological response information of the learner in response to the first learning image based on prior knowledge possessed by the learner. When the learning of the first learning image is completed, the processor 1702 may provide the learner with a second learning image different from the first learning image in terms of task complexity, collect psychophysiological response information associated with the second learning image from the learner learning the second learning image, analyze the psychophysiological response information collected while the learner is learning the first learning image and the second learning image based on the prior knowledge and the task complexity, and determine cognitive load in the learner for each learning interval based on the analyzed psychophysiological response information.

The processor 1702 may determine an achievement level of a learner based on whether a response to a question from the learner is correct or incorrect, determine a tension level of the learner based on psychophysiological response information of the learner that is obtained while the learner is responding to the question, and determine a learning level of the learner based on the achievement level and the tension level of the learner.

The learning situation determining apparatus 1700 may also perform other operations described above.

According to example embodiments described herein, it is possible to determine a cognitive state of a learner who learns a learning image based on a relationship between a psychological state of the learner and a physiological state of the learner by collecting psychophysiological response information of the learner while the learner is learning the learning image.

According to example embodiments described herein, it is possible to more accurately track a recall stimulus that induces a stimulated recall of a learner who learns a learning image from a previously learned learning image based on a learning content included in the learning image, by collecting stimulated recall response information of the learner on the stimulated recall while the learner is relearning a same learning content as the previously learned learning image that is already learned by the learner to collect psychophysiological response information of the learner.

According to example embodiments described herein, it is possible to determine a learning time point of a learning image at which cognitive load in a learner learning the learning image is generated while the learner is learning the learning image, and additionally design a learning level and an instructional method that are suitable for a cognitive level of the learner, by comparing a cognitive state of the learner in response to the learning image based on psychophysiological response information of the learner and a cognitive state of the learner in response to the learning image based on stimulated recall response information of the learner.

According to example embodiments described herein, it is possible to closely determine a learning level of a learner in association with an examination or test and provide a follow-up task corresponding to the determined learning level, by determining a learning level of the learner based on an achievement level and a tension level of the learner.

According to example embodiments described herein, it is possible to determine an accurate learning level of a learner who learns a learning image, even in an online learning environment, by evaluating a tension level of the learner in association with an examination or test based on psychophysiological response information including, for example, a skin conductance response, HRV information, and a skin temperature of the learner, and evaluating an achievement level of the learner based on a response to a question from the learner.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A learning situation determining method, comprising:
collecting psychophysiological response information to determine a change in psychological state and physiological state of a learner learning a first learning image, wherein the first learning image is an original moving image;
when the learning of the first learning image is completed, playing a second learning image including a same learning content as the first learning image for which the learning is completed, wherein the second learning image includes a mark of a stimulated recall of the learner;
collecting stimulated recall response information marked on the second learning image in response to the stimulated recall of the learner learning the second learning image; and
determining cognitive load in the learner that is recalled from the first learning image using the psychophysiological response information and the stimulated recall response information.

2. The learning situation determining method of claim 1, wherein the collecting of the psychophysiological response information comprises:
collecting the psychophysiological response information including brainwave information obtained by measuring a brainwave of the learner, pupil size information obtained by measuring a change in pupil size of the learner, and heart rate variability (HRV) information of the learner obtained by measuring a change in heart rate of the learner.

3. The learning situation determining method of claim 1, wherein the collecting of the stimulated recall response information comprises:
recording a learning content recalled by the learner while the learner is learning the second learning image;
dividing the second learning image into learning intervals based on a mark generation time at which a mark is generated by the learner; and
classifying a stimulated recall characteristic of each mark indicated on the second learning image based on the recorded learning content.

4. The learning situation determining method of claim 1, wherein the determining of the cognitive load comprises:
measuring a change in psychophysiological response information on the first learning image;
comparing cognitive load that is estimated through the change in psychophysiological response information of the learner and cognitive load that is verified through the stimulated recall response information of the learner;
verifying a range and interval of the psychophysiological response information of the learner that is describable by cognitive load in the learner that is recalled during learning, based on a result of the comparing; and
measuring cognitive load in the learner that is recalled from the first learning image based on the verified range and interval of the psychophysiological response information of the learner.

5. The learning situation determining method of claim 4, wherein the measuring of the change in psychophysiological response information comprises:
measuring a change in brainwave information of the psychophysiological response information based on a perceptual response of a brain of the learner that occurs due to cognitive load in the learner.

6. The learning situation determining method of claim 4, wherein the measuring of the change in psychophysiological response information comprises:
measuring a change in pupil size information of the psychophysiological response information based on whether a pupil size of the learner increases due to cognitive load in the learner.

7. The learning situation determining method of claim 4, wherein the measuring of the change in psychophysiological response information comprises:
measuring a change in HRV information of the psychophysiological response information based on an HRV that is a change in interval of a heart rate period occurring due to cognitive load in the learner.

8. The learning situation determining method of claim 4, wherein the comparing of the cognitive loads comprises:
comparing a learning interval of the first learning image that includes each peak value corresponding to each of a change in brainwave information, a change in pupil size information, and a change in HRV information that are included in the psychophysiological response information, and a learning interval of the second learning image that includes a peak value corresponding to a change in cognitive load.

9. A learning situation determining method comprising:
collecting psychophysiological response information on a first learning image from a learner learning the first learning image based on prior knowledge possessed by the learner;
when the learning of the first learning image is completed, providing the learner with a second learning image which is different from the first learning image in terms of task complexity;
collecting psychophysiological response information on the second learning image from the learner learning the second learning image;
analyzing the psychophysiological response information collected while the learner is learning the first learning image and the second learning image based on the prior knowledge and the task complexity; and
determining cognitive load in the learner for each learning interval based on the analyzed psychophysiological response information.

10. The learning situation determining method of claim 9, wherein the collecting of the psychophysiological response information on the first learning image comprises:
determining the prior knowledge through a pretest including a learning content to be learned by the learner, before the learning of the first learning image begins; and
classifying the learner into an upper group or a lower group based on the prior knowledge.

11. The learning situation determining method of claim 9, wherein the analyzing of the psychophysiological response information comprises:
analyzing the psychophysiological response information of the learner for each learning interval included in the first learning image and the second learning image by generating an average value of each of pupil size information and heart rate variability (HRV) information.

12. The learning situation determining method of claim 11, wherein the analyzing of the psychophysiological response information comprises:
analyzing the psychophysiological response information of the learner based on the pupil size information and the HRV information of the learner for each learning interval based on a level of task complexity that changes based on a time point at which the first learning image and the second learning image proceed.

13. A learning situation determining method comprising:
determining an achievement level of a learner based on whether a response to a question from the learner is correct;
determining a tension level of the learner based on psychophysiological response information of the learner obtained while the learner is responding to the question; and
determining a learning level of the learner based on the achievement level and the tension level of the learner.
